(19) United States
(12) Patent Application Publication
(10) Pub. No.: US 2026/0141823 A1
(43) Pub. Date: May 21, 2026

(54) METHODS AND SYSTEMS TO QUANTIFY CLINICAL CANNULATION SKILLS

(71) Applicant: Clemson University Research Foundation, Clemson, SC (US)

(72) Inventors: Ravikiran Singapogu, Pendleton, SC (US); Zhanhe Liu, Clemson, SC (US); Ziyang Zhang, Clemson, SC (US); Lydia Petersen, Clemson, SC (US); David Moline, Pendleton, SC (US); Devansh Shukla, Clemson, SC (US)

(21) Appl. No.: 19/451,675

(22) Filed: Jan. 16, 2026

Related U.S. Application Data
(63) Continuation-in-part of application No. 17/864,545, filed on Jul. 14, 2022, now Pat. No. 12,548,469.
(60) Provisional application No. 63/222,091, filed on Jul. 15, 2021.
(60) Provisional application No. 63/293,404, filed on Dec. 23, 2021.

(51) Int. Cl. G09B 23/28

(52) U.S. Cl. CPC G09B 23/285

(57) ABSTRACT

A medical training simulator system is disclosed for procedural skill development and objective feedback. The system includes a simulator base with a common physical interface for receiving modular anatomy units, each unit containing an embedded memory module storing calibration and geometry data. A sensor system features an array of light emitters and an instrumented medical needle with a light detection system to track needle position and detect events such as vessel entry. A controller automatically reads unit-specific data and configures signal processing to provide real-time feedback and infiltration alerts. The platform supports interchangeable anatomy modules simulating structures such as veins, lungs, and spines, enabling training for cannulation, biopsy, and epidural procedures. The system is designed for use in medical education and procedural assessment, offering modularity, accurate event detection, and user feedback to improve clinical skills.

### CROSS-REFERENCE TO RELATED APPLICATION(S)

This application claims priority as a continuation-in-part of U.S. patent application Ser. No. 17/864,545, filed Jul. 14, 2022 and entitled “Methods and Systems to Quantify Clinical Cannulation Skills,” which claims the benefit under 35 U.S.C. § 119 (e) to U.S. Provisional Application 63/222,091, filed Jul. 15, 2021 and entitled “Methods and Systems to Quantify Clinical Cannulation Skills,” U.S. Provisional Application 63/293,404, filed Dec. 23, 2021 and entitled “Methods and Systems to Quantify Clinical Cannulation Skills,” which are hereby incorporated herein by reference in their entirety.

### GOVERNMENT SUPPORT

This invention was made with government support under awarded grant number K01 DK111767 by the National Institutes of Health (NIH). The government has certain rights in the invention.

### FIELD

The various examples herein relate to medical skill training and evaluation.

### BACKGROUND

To receive life-sustaining hemodialysis treatments, patients with end-stage kidney disease (ESKD) may need to be cannulated in their vascular accesses at least 3 times a week in order to access their vascular system. Unfortunately, cannulation is a problem-ridden procedure for multiple reasons including non-standard geometries of arteriovenous fistulas (AVFs), lack of training opportunities for patient care technicians (PCTs) and a high turnover rate among PCTs in dialysis clinics. Lack of cannulation skill results in poor clinical outcomes due to infiltration and other cannulation-related trauma that could potentially lead to an unusable vascular access, which may be an unfavorable event for an ESKD patient. It is estimated that minor infiltration occurs in about 50% of cannulations while major infiltrations occur in 5-7% of cannulations in dialysis clinics. Another negative consequence of inadequate cannulation skill is that it increases reliance on Tunneled Dialysis Catheters (TDCs) whether due to not cannulating usable early fistulas (which usually requires greater skill) or due to a temporarily unusable vascular access. It has also been reported that injury during cannulation to a maturing AVF is associated with high maturation failure rates. Proper cannulation technique can also potentially reduce vessel wall trauma in vascular accesses that could prolong the life of the vascular access. In light of these realities, it is desired that cannulation be performed by skilled clinical personnel in a safe and effective manner since better cannulation skills will positively impact patient outcomes. Unfortunately, training of PCTs and nurses, specifically on the “technical” aspects of cannulation, has traditionally not received much attention. Pre-clinical training typically focuses on didactic instruction with “hands-on” training in cannulation comprising only a few attempts on an intravenous (IV) arm mannequin. These “fake arms” are antiquated tools that have limited value for the purpose of teaching cannulation for hemodialysis since they are unrealistic and cannot simulate a variety of vascular accesses. In addition, recent research has brought to light the fact that even though PCTs and nurses may possess several years of experience, they may remain in a state of being “perpetual novices” because of the lack of effective training options. The high turnover rate among PCTs further requires that training is both effective and efficient.

Simulators have been successfully deployed in many medical specialties for assessment and training of clinical skills. One of the key advantages of simulators is their ability to provide objective feedback of task performance. In addition, the trainee has the benefit of practicing skills in an artificial (simulated), safe, low-stakes environment; honing one's skills in this environment has the benefit of instilling confidence in the learner prior to actual clinical practice. Simulators have been demonstrated as being effective for skill assessment and training, particularly in surgical training, with several studies reporting successful transfer of training from the simulator to the operating room. Regrettably, however, simulators have not been as widely used in nursing, especially in the context of training clinical personnel in the dialysis unit, due to the fact that current products on the market lack objective assessment and training features and fail to be specifically adjusted for dialysis cannulation applications.

### BRIEF SUMMARY

A medical training simulator system is provided that enables realistic simulation of needle-based procedures using modular anatomy units. The system is designed to allow rapid interchangeability of anatomy modules, each of which can represent different anatomical structures and includes embedded memory for storing unit-specific calibration and geometry data. The simulator base features a standardized physical interface for receiving these modules, and a sensor system comprising an array of light emitters and an instrumented medical needle with a light detection subsystem. A controller is communicatively coupled to both the embedded memory and the sensor system, automatically reading the module-specific data and configuring signal processing to detect needle events and provide user feedback.

The system offers several benefits, including enhanced realism and flexibility in medical training. By supporting a variety of modular anatomy units, the simulator can replicate different clinical scenarios, anatomical variations, and procedural challenges. The use of embedded memory in each module ensures that calibration and geometry information remains accurate and specific to the module in use, improving the fidelity of needle event detection and feedback. The system's ability to process signals from multiple sensors and integrate with external computing devices, such as digital twin software, further expands its capabilities for advanced metrics, performance assessment, and scenario customization.

The system includes a simulator base configured to receive and support any of a plurality of modular anatomy units through a common physical interface. Each modular anatomy unit is detachably interchangeable and includes an embedded memory module with non-volatile memory storing unit-specific identification, calibration parameters, and geometry information. The sensor system detects the position of a needle relative to the anatomy unit and comprises an array of light emitters beneath the interface and an instrumented medical needle with a light detection system. The controller is communicatively coupled to the embedded memory and sensor system, automatically reading unit-specific data upon connection and configuring signal processing based on the calibration and geometry information to determine at least a vessel entry event and provide user feedback.

The system may further include an infiltration detection system that utilizes data from the light detection system and the unit-specific data to determine when the needle tip is detected outside a predefined boundary of the anatomy unit, providing an infiltration alert to the user. The array of light emitters may be arranged in a grid pattern, with the controller sequencing the emitters via time-division multiplexing based on the geometry information. The system can support concurrent monitoring of multiple instrumented medical needles, with visual indicators such as LEDs illuminating upon detection of vessel entry events. The common physical interface may include magnetic couplings, with fixed magnets in the simulator base and magnetic positioning aids in the anatomy units to ensure repeatable spatial alignment.

The modular anatomy units can simulate various anatomical structures, including peripheral veins, arteriovenous fistulas, synthetic grafts, spines and spinal cords, and lungs. The controller may perform sensor fusion by processing signals from the sensor system and additional sensors such as motion tracking systems or external cameras to determine metrics like needle trajectory, insertion velocity, and precise needle events. A user interface coupled to the controller can display computed metrics, including outcome, process, motion-based, time-based, location-based, and event-based metrics.

The controller can be communicatively coupled to an external computing device running a digital twin software model, transmitting signals from the light detection system for processing to calculate parameters such as stress, deformation, shear force, and fluid dynamics. The light detection system of the instrumented needle may include an internal fiber optic waveguide extending to the distal tip, conveying incident light to a photodetector for processing. The controller can selectively activate different patterns of the light emitter array for sensor readings based on the calibration and geometry information. For specific modules, such as lung or spine models, the arrangement of light emitters can be tailored to the clinical procedure being simulated, such as clustering emitters for biopsy points or modeling a spinal cord for epidural procedures.

A corresponding method is also provided for detecting needle events and determining needle position and orientation in the simulator. The method includes receiving a modular anatomy unit with embedded non-volatile memory, reading calibration and geometry information, sequencing the light emitter array using time-division multiplexing, detecting light with the instrumented needle, correlating detections to illumination patterns, and processing the data to compute needle position and orientation. The method may further include determining infiltration events, providing alerts, selectively activating emitter patterns, performing sensor fusion, monitoring multiple needles, illuminating visual indicators, transmitting data to digital twin models, and conveying light via fiber optic waveguides. The method supports coupling modular anatomy units via magnetic positioning aids for repeatable alignment.

The system and method described provide a flexible, accurate, and extensible platform for medical simulation, supporting a wide range of anatomical models, advanced sensing and feedback, and integration with external analysis and visualization tools.
In Example 1, a medical training simulator system comprises a simulator base configured to receive and support any of a plurality of modular anatomy units through a common physical interface; a first modular anatomy unit of the plurality of modular anatomy units, the first modular anatomy unit being detachably interchangeable with other of the plurality of modular anatomy units having different calibration information and geometry information, the first modular anatomy unit including an embedded memory module comprising non-volatile memory storing unit-specific data including identification, calibration parameters, and geometry information for the first modular anatomy unit; a sensor system configured to detect a position of a needle relative to the first modular anatomy unit, the sensor system comprising: an array of light emitters disposed beneath the common physical interface that receives the first modular anatomy unit; and an instrumented medical needle having a light detection system; and a controller communicatively coupled to the embedded memory module and the sensor system, the controller being configured to: automatically read the unit-specific data from the non-volatile memory upon connection of the modular anatomy unit to the simulator base; and configure processing of signals from the sensor system based on the calibration parameters and geometry information to determine at least a vessel entry event and provide user feedback.
Example 2 relates to the system of Example 1, further comprising: an infiltration detection system configured to: utilize data from the light detection system and the unit-specific data to determine, by the controller, an infiltration event when the needle tip is detected outside a predefined boundary of the first modular anatomy unit; and provide an infiltration alert to the user.
Example 3 relates to the system of Example 1, wherein the array of light emitters is arranged in a grid pattern, and wherein the controller is configured to sequence the emitters via time-division multiplexing based on the geometry information for the first modular anatomy unit.
Example 4 relates to the system of Example 1, further comprising: a second instrumented medical needle, wherein the controller is configured to monitor positions of the first and second instrumented medical needles concurrently during a single cannulation trial.
Example 5 relates to the system of Example 4, further comprising: a visual indicator associated with each instrumented medical needle, each visual indicator comprising a light-emitting diode that illuminates upon detection of the vessel entry event by the corresponding instrumented medical needle.
Example 6 relates to the system of Example 1, wherein the common physical interface comprises magnetic couplings; the simulator base including a plurality of fixed magnets; and the plurality of modular anatomy units including magnetic positioning aids configured to mate with the fixed magnets to ensure repeatable spatial alignment of the modular anatomy unit relative to the array of light emitters.
Example 7 relates to the system of Example 1, wherein the plurality of modular anatomy units is configured to simulate anatomical structures selected from the group consisting of: a peripheral vein; an arteriovenous fistula; a synthetic graft; a spine and spinal cord arrangement; and a lung.
Example 8 relates to the system of Example 1, wherein the controller is further configured to perform sensor fusion to determine metrics comprising needle trajectory, insertion velocity, and precise needle events by processing signals from the sensor system and signals from at least one additional sensor selected from the group consisting of: a motion tracking system; a force sensor; a hand tracking system; an inertial measurement unit; and an external camera.
Example 9 relates to the system of Example 1, further comprising: a user interface coupled to the controller, the user interface comprising a hardware display or a graphical user interface, the user interface configured to display one or more computed metrics including at least one of: outcome metrics; process metrics; motion-based metrics; time-based metrics; location-based metrics; and event-based metrics.
Example 10 relates to the system of Example 1, wherein the controller is communicatively coupled to an external computing device running a digital twin software model, the controller configured to transmit signals from the light detection system to the external computing device for processing by the digital twin software model to calculate parameters including: stress on the modular anatomy unit; deformation of simulated tissue; shear force; and fluid dynamics.
Example 11 relates to the system of Example 1, wherein the light detection system of the instrumented medical needle comprises an internal fiber optic waveguide extending to or proximate a distal tip of the needle, the internal fiber optic waveguide being configured to convey incident light from the distal tip to a photodetector located in the base or the controller, the controller processing signals derived therefrom based on the anatomy-specific calibration parameters and geometry information to detect at least a vessel entry event.
Example 12 relates to the system of Example 1, wherein the controller is configured to selectively activate different patterns of the array of light emitters for sensor readings based on the calibration parameters and geometry information stored in the embedded memory module for the first modular anatomy unit.
Example 13 relates to the system of Example 1, wherein the first modular anatomy unit comprises a model of a lung, and wherein the array of light emitters are arranged in clusters in areas where a biopsy is to be performed.
Example 14 relates to the system of Example 1, wherein the first modular anatomy unit comprises a model of a spine, and wherein at least a portion of the array of light emitters are arranged to model a spinal cord such that, if the light detection system detects light emitted by any of the portion of the array of light emitters, the light detection system indicates that the instrumented medical needle passed a simulated epidural space and entered the spinal cord.
Example 15 relates to the system of Example 1, wherein the sensing arrangement comprises an infrared sensing system, and wherein the controller is further configured to estimate outputs of one or more additional sensors including at least one of a motion sensor and a force sensor by applying model-based or data-driven inference techniques that map temporally distinct infrared detections, identified emitter contributions, and geometry-constrained needle tip trajectories to generate surrogate kinematic signals and interaction force signals, the controller performing the estimation based on the calibration parameters and geometry information stored in the EEPROM.
Example 16 relates to the system of Example 1, further comprising one or more additional sensors, wherein the controller is further configured to estimate spatial information of the instrumented medical needle from sensor data gathered by the one or more additional sensors to generate a prediction of cannulation performance based on the positioning of the instrumented medical needle or a user posture relative to the vessel module, the sensor data including user behavior prior to insertion of the instrumented medical needle.
In Example 17, a method of detecting needle events and determining needle position and orientation in a medical simulator is described, the method comprising: receiving, at a simulator base, a modular anatomy unit comprising an embedded non-volatile memory storing anatomy-specific calibration parameters and geometry information; reading, by a controller, the anatomy-specific calibration parameters and geometry information from the embedded non-volatile memory; sequencing, by the controller, an array of light emitters using time-division multiplexing to generate a plurality of temporally distinct illumination patterns defined in accordance with the calibration parameters and geometry information; detecting, by a light detection system of an instrumented medical needle, light corresponding to the temporally distinct illumination patterns while the instrumented medical needle is manipulated relative to the modular anatomy unit; correlating, by the controller, detections from the light detection system to the temporally distinct illumination patterns to identify emitter contributions and to determine at least one needle event; and processing, by the controller, the correlated detections using the calibration parameters and geometry information to compute a needle position and orientation associated with the at least one needle event.
Example 18 relates to the method of Example 17, further comprising: performing sensor fusion by processing signals from the light detection system and at least one additional sensor selected from the group consisting of a motion tracking system, a force sensor, a hand tracking system, an inertial measurement unit, and an external camera to determine metrics comprising needle trajectory and insertion velocity.
Example 19 relates to the method of Example 17, further comprising: monitoring positions of first and second instrumented medical needles concurrently during a single cannulation trial; and correlating detections for each needle to determine respective needle events.
Example 20 relates to the method of Example 19, further comprising: illuminating a visual indicator associated with each instrumented medical needle upon occurrence of a vessel entry event for the corresponding needle.
Example 21 relates to the method of Example 17, further comprising: transmitting the correlated detections to an external computing device running a digital twin software model; and calculating at least one parameter selected from the group consisting of stress on the modular anatomy unit, deformation of simulated tissue, shear force, and fluid dynamics.
Example 22 relates to the method of Example 17, wherein detecting light comprises conveying incident light from a distal tip of the instrumented medical needle through an internal fiber optic waveguide to a photodetector of the controller.
Example 23 relates to the method of Example 17, wherein the temporally distinct illumination patterns correspond to a grid pattern arrangement of the array of light emitters.
Example 24 relates to the method of Example 17, wherein receiving the modular anatomy unit comprises coupling, via a common physical interface, a selected one of a plurality of detachably interchangeable modular anatomy units, each modular anatomy unit including an embedded non-volatile memory storing anatomy-specific identification, calibration parameters, and geometry information, and wherein coupling includes magnetically mating positioning aids of the selected modular anatomy unit to fixed magnets of the simulator base to provide repeatable spatial alignment relative to the array of light emitters.
Example 25 relates to the method of Example 17, further comprising: determining an infiltration event when the detected needle tip is positioned outside a predefined boundary of the modular anatomy unit; and providing an infiltration alert to a user.
Example 26 relates to the method of Example 17, further comprising estimating, by the controller, outputs of one or more additional sensors including at least one of a motion sensor and a force sensor by applying model-based or data-driven inference techniques that map temporally distinct infrared detections, identified emitter contributions, and geometry-constrained needle tip trajectories to generate surrogate kinematic signals and interaction force signals, the estimating being performed based on the calibration parameters and geometry information read from the embedded non-volatile memory.
Example 27 relates to the method of Example 17, wherein sequencing comprises selectively activating different patterns of the array of light emitters based on the calibration parameters and geometry information.
Example 28 relates to the method of Example 17, further comprising estimating, by the controller, spatial information of the instrumented medical needle from sensor data gathered by one or more additional sensors to generate a prediction of cannulation performance based on the positioning of the instrumented medical needle or a user posture relative to the vessel module, the sensor data including user behavior prior to insertion of the instrumented medical needle.
In Example 29, a method is described for performing any of the techniques of any combination of Examples 1-28.
In Example 30, a device is configured to perform any of the techniques of any combination of Examples 1-28.
In Example 31, an apparatus comprises means for performing any of the techniques of any combination of Examples 1-28.
In Example 32, a non-transitory computer-readable storage medium has stored thereon instructions that, when executed, cause one or more processors of a computing device to perform the techniques of any combination of Examples 1-28.
In Example 33, a system comprises one or more computing devices configured to perform a techniques of any combination of Examples 1-28.
In Example 34, any of the techniques described herein are included.

While multiple examples are disclosed, still other examples will become apparent to those skilled in the art from the following detailed description, which shows and describes illustrative examples. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular embodiments of the present disclosure and do not limit the scope of the subject matter described. The drawings are not necessarily to scale, though examples can include the scale illustrated, and are intended for use in conjunction with the explanations in the following detailed description wherein like reference characters denote like elements. Embodiments of the present disclosure will hereinafter be described in conjunction with the appended drawings.

FIG. 1 is a conceptual diagram illustrating a physical cannulation simulator that includes sensors and a computing device configured to analyze data produced by the sensors to assess a user's performance during a physical cannulation simulation, in accordance with the techniques described herein.

FIG. 2 is a block diagram illustrating a more detailed example of a computing device configured to perform the techniques described herein.

FIG. 3 illustrates a flowchart diagram depicting an example method for computing needle position and orientation using light emitter sequencing and correlated detections, in accordance with the techniques described herein.

FIG. 4 is a photograph illustrating an example simulator base and vessel module configured for modular anatomy unit integration, in accordance with the techniques described herein.

FIG. 5 illustrates a mechanical drawing of the simulator base components, including example magnets, positioning aids, a memory module, and a motor, in accordance with the techniques described herein.

FIG. 6 is a photograph illustrating example modular anatomy units designed for cannulation training with instrumented medical needles, in accordance with the techniques described herein.

FIG. 7 is a photograph illustrating an example dialysis needle integrated with a fiber optic cable for light signal detection, in accordance with the techniques described herein.

FIG. 8 is a photograph illustrating example simulator components, including instrumented needles, infrared emitters, and flashback LEDs, in accordance with the techniques described herein.

FIG. 9 is a photograph illustrating example controller and buzzer components of the medical training simulator system, in accordance with the techniques described herein.

FIG. 10 illustrates a flowchart of an example sensor fusion process for determining needle position and generating feedback indicators, in accordance with the techniques described herein.

FIG. 11 is a photograph illustrating an example cannulation simulator system, including the simulator base unit with indicators and a display showing cannulation data, in accordance with the techniques described herein.

FIG. 12 illustrates a system diagram of an example cannulation training simulator system connected to a laptop with a user interface via a communication cable, in accordance with the techniques described herein.

FIG. 13 illustrates a biological diagram of an example epidural simulation using an LED array to differentiate the epidural space from deeper nerve structures near the spine, in accordance with the techniques described herein.

FIG. 14 illustrates a biological diagram of an example lung with designated points of interest for biopsy procedures, in accordance with the techniques described herein.

### DETAILED DESCRIPTION

The present detailed description provides illustrative embodiments of the disclosed technology, which generally pertains to systems and methods for medical training simulators, particularly those designed to simulate anatomical structures and detect needle events with high precision. The disclosed technology leverages advanced sensor systems, modular components, and data processing techniques to enhance the realism and accuracy of medical training scenarios, such as cannulation, epidural procedures, and lung biopsies. The described embodiments are intended to provide a comprehensive understanding of the functionality and applications of the disclosed technology within the field of medical simulation.

The examples and embodiments described herein are provided for illustrative purposes only and are not intended to limit the scope of the described subject matter. Certain details, such as standard components or techniques well-known to those skilled in the art, may be omitted for clarity and brevity. Furthermore, the described subject matter includes various modifications, rearrangements, and alternative configurations that fall within the scope of the claims, including variations in sensor arrangements, modular anatomy units, and data processing methods.

The field of medical training simulators, particularly those designed for needle-based procedures, has long faced challenges in providing realistic, accurate, and adaptable training environments. Conventional systems often lack modularity, precise feedback mechanisms, and the ability to simulate diverse anatomical scenarios. These limitations hinder the ability to train medical professionals effectively, as existing simulators fail to replicate the nuanced tactile and visual feedback required for procedures such as vascular access, epidural injections, and biopsies. Furthermore, traditional simulators are often unable to provide real-time, data-driven feedback or integrate with advanced computational models to enhance training outcomes.

One significant limitation of prior systems is their inability to adapt to different anatomical configurations or provide accurate calibration for various training scenarios. Many existing simulators rely on static, non-interchangeable components, which restrict their utility to a narrow range of procedures. Additionally, these systems often lack the capability to detect and respond to significant events, such as vessel entry or infiltration, with high precision. The absence of advanced sensor integration and real-time data processing further limits their effectiveness in providing actionable feedback to users. Moreover, traditional systems do not leverage modern computational techniques, such as sensor fusion or digital modeling, to simulate complex physical phenomena like tissue deformation, stress, or fluid dynamics.

The present disclosure addresses these shortcomings by introducing a modular, sensor-integrated medical training simulator system that combines advanced hardware and software innovations. The system features a simulator base with a common physical interface designed to support a variety of modular anatomy units, each equipped with an embedded memory module storing unit-specific calibration and geometry data. This modularity facilitates seamless interchangeability and accurate calibration across diverse anatomical scenarios, such as peripheral vessels, composite vascular structures, synthetic conduits, spinal arrangements, and pulmonary models. The inclusion of a fiber optic-based instrumented medical needle, coupled with an array of light emitters and a controller, enables precise detection of needle events, such as vessel entry or infiltration, through time-division multiplexing and real-time signal processing.

The system further enhances training efficacy by integrating sensor fusion techniques, combining data from the light detection system with additional sensors, such as motion trackers or cameras, to compute advanced metrics like needle trajectory, insertion velocity, and event-based outcomes. Additionally, the system supports connectivity with external computing devices running digital modeling software, enabling the simulation of complex physical parameters, including tissue stress, deformation, and fluid dynamics. These capabilities provide trainees with a highly realistic and data-rich training environment, offering immediate feedback and performance metrics through a user interface.

By addressing the limitations of prior systems and introducing a highly adaptable, data-driven solution, the present system significantly improves the realism, versatility, and educational value of medical training simulators. This approach not only enhances the training experience for medical professionals but also contributes to improved patient outcomes by fostering greater procedural accuracy and confidence.

This disclosure is directed to a medical training simulator using specific, concrete hardware arrangements and control techniques that detect and evaluate needle events in physical space. The techniques described herein include time-division multiplexing control of a physical array of emitters, fiber-optic light detection at a needle tip, and module-specific calibration stored in embedded non-volatile memory to achieve improved, real-time detection of vessel entry, infiltration, and precise needle position and orientation within a tangible training apparatus.

The techniques described herein recite a simulator base physically configured to receive interchangeable modular vessel/anatomy units via a common interface, an embedded memory (e.g., EEPROM) within each modular unit storing unit-specific identification, calibration parameters, and geometry information, an instrumented cannulation needle with a light detection system comprising an internal fiber optic waveguide extending to or proximate the distal tip, an array of light emitters disposed beneath the modular unit, and a controller configured to automatically read the unit-specific data upon connection and to sequence the emitters via time-division multiplexing and process detections to determine needle events and provide feedback. The method claims likewise require physically sequencing the emitter array using time-division multiplexing to generate temporally distinct illumination patterns, detecting those patterns with the fiber-optic needle, correlating detections to specific emitters, and computing needle position and orientation in relation to anatomy-specific geometry retrieved from the embedded memory.

These elements are not field-generic components used for routine data processing. Rather, they define a specific sensor architecture and control scheme that improves the technological capability of training simulators to detect, localize, and evaluate needle interactions. For example, sequencing the array of emitters via time-division multiplexing to generate temporally distinct illumination patterns is a hardware-level control strategy applied to a physical emitter array to disambiguate spatial contributions and yield accurate position/orientation results. Similarly, the use of a fiber optic waveguide integrated into the needle to convey incident light from the distal tip to a photodetector, combined with anatomy-specific geometry and calibration stored in an embedded non-volatile memory on the modular unit, yields improved signal-to-noise performance and reduces misclassification of events such as vessel entry and infiltration. These improvements are technological.

The techniques described herein apply the concept to control and sense physical phenomena in a simulated anatomical environment. The controller's automatic reading of module-specific calibration and geometry from an embedded non-volatile memory upon connection, the magnetic alignment interface to ensure repeatable spatial registration between the module and emitter array, the selective activation of different emitter patterns based on the stored calibration and geometry, and the detection/correlation of temporally distinct illumination at the distal needle tip together provide a specific improvement in the operation of a medical simulator. The output is immediate, physical feedback (e.g., flashback indicator LEDs, buzzer alerts) and computed metrics tied to real-world needle manipulation in a physical training device. This is more than data reporting. It is a concrete control-and-sensing solution that changes the way the simulator operates to achieve improved performance.

The techniques described herein additional elements, including a specialized sensor configuration (fiber-optic needle tip and photodetector path), a hardware emitter array driven by time-division multiplexing, embedded calibration/geometry in EEPROM on the interchangeable modules for automatic per-module configuration, a common physical interface with magnetic couplings to ensure repeatable spatial alignment, and event-specific physical feedback. The ordered combination of these elements provides a technical solution to a technical problem (e.g., improving the fidelity and accuracy of needle event detection and position/orientation estimation in a medical training simulator).

The techniques described herein further include infiltration detection based on predefined module boundaries, concurrent tracking of multiple instrumented needles with respective visual indicators, selective activation of different emitter patterns tailored to module geometry (including grid, cluster, or linear arrangements for different procedures such as cannulation, biopsy, or epidural), sensor fusion with motion tracking or camera inputs to compute trajectory and insertion velocity, and coupling to a digital twin model to calculate physical parameters such as stress, deformation, shear force, and fluid dynamics based on measured signals. Each of these features ties computation to specific physical measurements and hardware operations within the simulator environment to achieve improved training outcomes.

An example real-life implementation is a hemodialysis cannulation trainer deployed in a teaching hospital. The simulator base is a benchtop platform shaped and sized to mimic a forearm segment and includes a common physical interface with four recessed fixed magnets positioned at registered coordinates relative to an emitter plane. An infrared emitter array board is mounted approximately 8 mm below the module interface and comprises a 24-by-16 matrix of surface-mount infrared light emitters with a peak near 940 nm, each addressable through row and column drivers. A haptic vibration motor is positioned under a proximal arterial segment to simulate a palpable thrill associated with fistula training. A microcontroller-based controller board, such as an ARM Cortex-M4 device, provides two high-speed general-purpose input/output matrices for time-division multiplexing control of the emitter array, dual photodiode front-ends (transimpedance amplifiers) for dual-needle operation, a magnetometer or Hall sensor pair to confirm module seating and alignment, and wired and wireless connectivity options including USB-C, Ethernet, and Bluetooth Low Energy. The base includes a sealed compartment housing an audible buzzer and LED status indicators.

Interchangeable vessel modules include, for example, an arteriovenous fistula module constructed from silicone and urethane composite with an embedded vessel lumen geometry at a depth of about 4.5 mm and an internal diameter of about 7.5 mm, a reinforced wall, and a palpable thrill path. The module includes an I2C-accessible electrically erasable programmable read-only memory storing identification, calibration parameters, and geometry information, such as an optical attenuation map, emitter gain coefficients, ambient-light thresholds, tip coupling efficiency, vessel boundary spline control points, and mapping from emitter indices to anatomical coordinates. Geometry information further includes a lumen path polyline, wall thickness map, and recommended insertion angles for arterial and venous sticks. Additional modules include a peripheral vein module having smaller lumen dimensions at variable depths and a synthetic graft module with parameters mimicking a 6 mm PTFE graft with higher specular reflection characteristics. Each module mates to the base via magnetic positioning aids that engage the fixed magnets to ensure repeatable spatial alignment relative to the emitter array.

Instrumented cannulation needles include a 17-gauge dialysis needle with an internal fiber optic waveguide terminating within approximately 0.5 mm of the bevel tip, configured with a sterile, single-use sheath over a reusable sensor cartridge that mates to a low-profile hub, which couples a plastic optical fiber to the controller photodiode front-end. A second practice needle, such as an 18-gauge needle, is equipped with an identical optical path to support dual-needle training. Each needle carries a flashback visual indicator, for example an LED positioned at the hub, that is driven upon detection of a vessel entry event.

During operation, an instructor seats the selected module, such as the arteriovenous fistula module, onto the base. Magnetic positioning aids mate with the fixed magnets to establish repeatable alignment. The controller detects module presence via the Hall sensors and reads the EEPROM to load identification, calibration parameters, and geometry information into memory. A seating and alignment self-check is performed by activating a sparse time-division multiplexed test pattern, comparing photodetector baselines under a cover, and validating spatial registration against the module's embedded alignment table. Upon successful validation, a user interface indicates module readiness. Prior to training, the controller measures ambient infrared levels and sets per-emitter duty cycles. Adaptive time-division multiplexing sequencing is enabled, grouping emitters into banks to maintain frame timing under approximately 2 milliseconds per full cycle. For the fistula module, the controller selects a grid pattern optimized for the stored attenuation map and geometry, increasing drive current within safe limits and lengthening integration windows in regions of higher attenuation.

A trainee palpates the thrill generated by the haptic motor, identifies the target segment, and inserts the instrumented needle at a shallow angle recommended in the module geometry information. As the tip approaches the vessel wall, the fiber optic waveguide captures infrared light transmitted and reflected through the tissue composite. The photodiode signal is sampled synchronously with the time-division multiplexing patterns, and the controller correlates detections to active emitter indices to compute the tip's three-dimensional position and local surface normal relative to the lumen boundary. Upon crossing the inner wall boundary defined in the geometry information, the controller detects a vessel entry event based on characteristic changes in signal patterns and geometric constraints and illuminates the needle's flashback indicator while logging the event on the user interface.

If the trainee advances the needle beyond the lumen boundary or outside a predefined exterior boundary, the controller identifies an infiltration event, suppresses the flashback indicator, and activates the buzzer in the base. The user interface highlights the event and displays the tip path over the lumen model with corrective feedback, such as advising reduction of insertion depth or adjustment of angle to align with the vessel axis. In dual-needle scenarios, concurrent monitoring mode is enabled and a second needle is inserted for arterial and venous sticks. The controller multiplexes two photodiode channels with interleaved time-division multiplexing schedules and separates detections on a per-needle basis. Each needle's hub LED is tied to its own event logic to allow independent flashback confirmations.

Sensor fusion augments optical detections with data from a motion tracker mounted on the trainee's wrist. The controller fuses acceleration and orientation inputs with optical detections, for example using a Kalman filter, to refine insertion velocity and trajectory estimates. The system computes and displays process metrics such as time to flashback and number of wall contacts, motion-based metrics such as peak insertion velocity and approach angle deviation, event-based metrics such as first vessel entry time and infiltration occurrences, and location-based metrics including final tip position relative to a lumen centerline and wall. The controller streams correlated detections to an external computing device running a digital twin module, which uses the module geometry and material parameters to compute physical parameters, including local wall stress around the puncture site, tissue deformation along the insertion path, shear forces due to needle translation, and simulated flow changes upon successful arterial or venous access. Results are visualized as overlays on the lumen model and saved with the trainee's session.

At the conclusion of a session, the instructor may swap to a peripheral vein module, where the controller automatically loads its EEPROM contents and adjusts time-division multiplexing patterns to a finer grid, shortens integration windows, and applies a different attenuation model. The trainee repeats cannulation with a smaller-gauge needle, and the system evaluates delicate wall handling and shallow-depth targeting. Representative engineering considerations include maintaining a full time-division multiplexing cycle under approximately 2 milliseconds to achieve sub-50 millisecond latency from event detection to indicator activation, spatial localization error under about 0.8 mm root-mean-square in a central training area verified against a calibrated phantom, and adaptive ambient-light compensation to maintain signal integrity in bright clinical laboratory conditions. Hygiene and safety are addressed through sealed, wipeable modules, disposable needle sheaths, and emitter operation within applicable photobiological safety limits.

The same platform extends to other procedures. An epidural trainer module employs linear LED arrangements representing epidural boundaries, with selective activation focusing on detecting epidural entry while avoiding deeper emitters corresponding to nerve structures; inadvertent deep penetration triggers a distinct alert profile. A lung biopsy module employs clustered emitters at points of interest to emphasize targeting accuracy; materials are formulated to be ultrasound-compatible, and the system scores proximity and dwell time at the target region. This implementation demonstrates how interchangeable modules with embedded EEPROMs, fiber-optic instrumented needles, and time-division multiplexed emitter arrays cooperate with a controller and external user interface to deliver precise event detection, localization, and actionable training feedback across a range of cannulation scenarios.

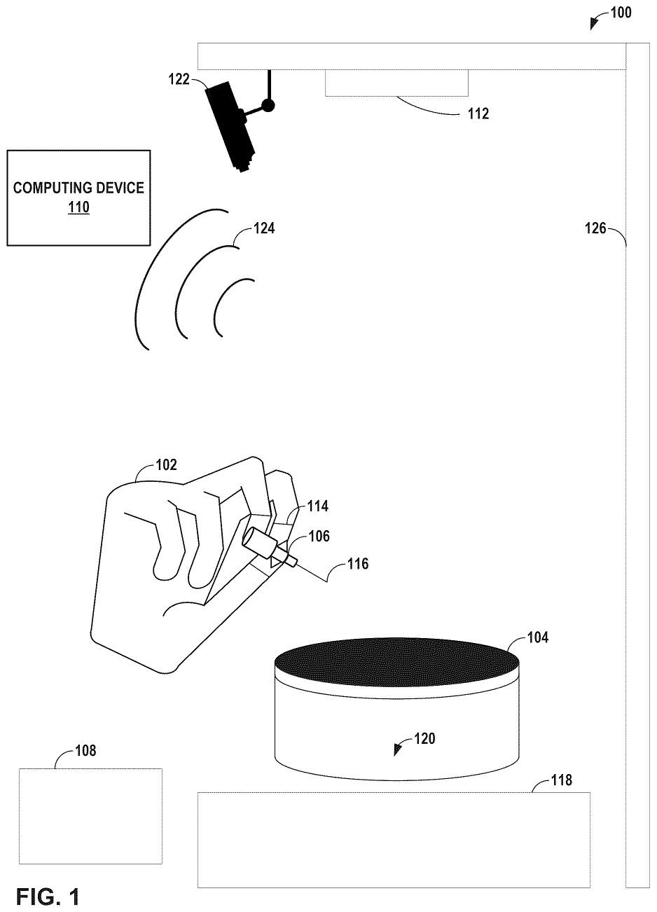

FIG. 1 is a conceptual diagram illustrating a physical cannulation simulator system 100 that includes sensors 112, 114, 116, 118, 120, and 122, and a computing device 110 configured to analyze data produced by the sensors to assess a user's performance during a physical cannulation simulation, in accordance with the techniques described herein. Physical cannulation simulator system 100 may be utilized by a user, such as a user with hand 102, to perform a physical cannulation simulation that may be helpful for training purposes as various clinicians and other medical professionals train to perform cannulation procedures without subjecting actual patients to the pricks and punctures that occur during a cannulation procedure.

The example of FIG. 1 includes physical cannulation simulator 104. Physical cannulation simulator 104 may be any device with a surface penetrable by a needle, such as cannulation needle 106, in order to give the user an experience similar to performing a cannulation on a human patient. For instance, physical cannulation simulator may be an object that includes at least one surface made of a simulated skin, such as an animal skin or a synthetic elastomer, that is tightened and filled such that the surface has properties similar to human skin. In some instances, the simulated skin surface may be replaceable such that the same physical cannulation simulator device can be reused after the surface has been punctured by cannulation needle 106. Inside physical cannulation simulator 104 may be any of a variety of sensors, including infrared emitters 120, to provide feedback to control box 108 and/or computing device 110.

Cannulation needle 106 may be any needle similar to those used to perform actual cannulation procedures. For instance, cannulation needle 106 may be shaped and weighted in a manner that is similar to needles used in live cannulation procedures. In some instances, cannulation needle 106 may include one or more needle sensors 116 inside the tip of the needle or on a surface of the needle portion of cannulation needle 106.

In some instances, physical cannulation simulator system 100 may include control box 108. In some instances, control box 108 may be any type of computing device that can receive signals 124 from various sensors within physical cannulation simulator system 100. Control box 108 may compile signals 124 and forward signals 124 to computing device 110 for analysis. In other instances, control box 108 may analyze the data received from the variety of sensors itself, performing the tasks hereby attributed to computing device 110. In still other instances, control box 108 may not be included in physical cannulation simulator system 100, with the various sensors communicating directly with computing device 110 with signals 124.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. Computing device 110 may receive sensor data either directly from the variety of sensors in physical cannulation simulator system 100 or from control box 108 in a compiled form.

As stated above, physical cannulation simulator system 100 may include a variety of sensors. For instance, physical cannulation simulator system 100 may include optical hand tracking sensor system 112. Optical hand tracking sensor system 112 may be installed onto frame 126 that extends above physical cannulation simulator 104 and may be directed downwards towards physical cannulation simulator 104. As such, optical hand tracking sensor system 112 may include one or more motion tracking sensors in an optical hand tracking sensor module that can identify hand 102 and track hand 102 as it moves in the vicinity of physical cannulation simulator 104. Optical hand tracking sensor system 112 may generate motion data and tracking data that is transmitted to either control box 108 or computing device 110 for analysis.

Physical cannulation simulator system 100 may also include pressure sensor system 114.

Pressure sensor system 114 may include one or more pressure sensors, with each pressure sensor being attached to a hand garment or hand covering that is worn on hand 102 and with each pressure sensor corresponding to a particular digit of hand 102. For instance, pressure sensor system 114 may include three different pressure sensors, one on each of a thumb, an index finger, and a middle finger of hand 102. In other instances, pressure sensor system 114 may only include pressure sensors on an index finger, an index finger and a thumb, on all five fingers, or any combination of fingers that may produce adequate pressure information. In some instances, a user may have a pressure sensor system 114 on each hand such that pressure information can be gathered for pressure onto cannulation needle 106 as well as the simulated skin surface of physical cannulation simulator 104.

Physical cannulation simulator system 100 may also include one or more needle sensors 116 located either within a needle portion of cannulation needle 106 or on a surface of the needle portion of cannulation needle 106. Needle sensors 116 may include an infrared detector. The infrared detector may include a sensor configured to detect infrared light emitted by an infrared emitter, such as infrared emitters 120. In this way, if infrared emitters 120 are positioned to mimic a location of a fistula within physical cannulation simulator 104, the infrared detector may detect the emitted infrared light once cannulation needle is in the proper position. Additionally or alternatively, needle sensors 116 may include an electromagnetic sensor configured to work with electromagnetic position sensor system 118. The electromagnetic sensor may detect emitted electromagnetic energy, with the strength of the detected energy enabling the electromagnetic sensor to determine or convey position and location information to control box 108 or computing device 110.

Physical cannulation simulator system 100 may also include electromagnetic position sensor system 118. Electromagnetic position sensor system 118 may emit electromagnetic energy in a way that the particular magnitude of the energy, as picked up by an electromagnetic sensor, such as that included in needle sensors 116, can imply positional and location information of the electromagnetic sensor. As the electromagnetic sensor is incorporated into cannulation needle 106 and the electromagnetic position sensor system 118 is in a consistent position, the location information of the electromagnetic sensor may indicate the position of cannulation needle 106.

Physical cannulation simulator system 100 may also include infrared emitters 120. As described above, infrared emitters 120 may work with an infrared sensor in needle sensors 116 to provide information as to whether cannulation needle 106 is in the correct location. For instance, infrared emitters 120 may be arranged to simulate one or more fistula within physical cannulation simulator 104, including being located at a depth within physical cannulation simulator 104 that may correspond to a typical depth beneath the skin of a fistula in a human subject. As such, once cannulation needle 106 is moved to be within the simulated fistula at the correct depth, the infrared sensor in needle sensors 116 may detect the infrared light emitted by infrared emitters 120 to indicate that cannulation needle 106 is at the correct location and at the correct depth.

Physical cannulation simulator system 100 may also include external camera system 122. External camera system 122 may be fixed, in some instances, to frame 126. In other instances, external camera system 122 may be located at any space that has a clear view of physical cannulation simulator 104 and hand 102 such that external camera system 122 can capture video of the physical cannulation simulation process.

Any of sensors 112, 114, 116, 118, 120, and 122 can generate instances of signals 124 to transmit data to one of control box 108 and computing device 110. Signals 124 may take the form of any wired or wireless communication that enables the sensors to communicate the measured data with control box 108 or computing device 110. Signals 124 may follow various protocols for such transmissions, including WiFi®, Bluetooth®, ZigBee®, cellular, radio, or any other wired or wireless protocol.

In accordance with the techniques described herein, any one or more of sensors 112, 114, 116, 118, 120, and 122 may measure data during a physical cannulation simulation performed on physical cannulation simulator 104. The sensors may transmit the data to control box 108 or computing device 110 by transmitting signals 124. Computing device 110 receives signals 124 and the data measured by each of the one or more sensors. Computing device 110 calculates a plurality of metrics using the data. Computing device 110 applies a model to the plurality of metrics to determine a composite simulation success score. Computing device 110 compares the composite simulation success score to a threshold score. In response to comparing the composite simulation success score to the threshold score, computing device 110 outputs an indication of one or more of an absolute performance or a relative performance for the first user during the physical cannulation simulation.

A custom designed cannulation simulator was designed for use with these techniques consisting of three primary components: simulator hardware, sensing systems, and a control unit. However, any physical cannulation simulator can be used for the purposes of this disclosure, so long as the sensors that provide the adequate data are present. The simulator body may be a 3D printed frame that allows the simulator body to be rotated 360-degrees. There may be up to four or more cannulation modules on each side of the rotatable frame as shown. Each cannulation module may be filled with foam to simulate body mass. Fistula models with distinct geometric properties made of silicone gel may be placed within the foam. There may be a variety of fistulas with the various properties, including straight or curved and between 5 and 11 millimeters (e.g., 7 mm or 9 mm), although other sizes may be utilized for certain circumstances.

Within each fistula model, a vibration motor may be embedded to render feedback for palpation. By controlling the power and frequency of the vibration, the characteristic “thrill” haptic sensation of blood flow in an AVF is simulated. An optical hand tracking sensor may be attached to a pole above the cannulation platform to capture subjects' hand movements during palpation. Furthermore, the pressure sensor force recording system may be used to record forces exerted on the surface during palpation. Three finger sleeves may be placed on the user's thumb, index finger, and middle finger since these three fingers are most used during cannulation, although other fingers can also be covered. In addition to the motor, an infrared (IR) emitter-detector system may be embedded inside the fistula to identify whether the needle was inserted into the fistula model. Based on the IR detector's voltage, a red LED may light up to mimic the blood flashback during clinical cannulation. On top of the foam and fistula model, a layer of artificial skin was placed. To track the motion of the needle throughout the cannulation process, an electromagnetic (EM) tracking system may be used. The sensor may be fixed inside a 15G dialysis needle, with the field generator facing the cannulation platform for motion capture. A web camera may be placed outside of the simulator area to record the cannulation process for review.

Segmentation may be performed to isolate sensor data during the palpation portion. The start time of palpation (Tₛₜₐᵣₜ) may be defined as the time when force was applied to the index or middle finger after a period of no change in force. The initial period of accounting for no change in force is designed to detect trials where the user was not in the starting hand position. The end time of palpation (Tend) may be found by searching for a change in force applied by the thumb in conjunction with a movement of the needle since typically at the end of palpation, the needle will be gripped by the subject for insertion, resulting in pinch forces and needle movement. This segmentation strategy works for the typical palpation trial where the subject palpates with the index and middle fingers, while the needle is held or placed relatively still. Metrics are split up into three types: the time metric, location metrics, and force metrics.

Time Metric: (Time) is the total time from the start of palpation to the end.

$$Time = {T}_{end} - {T}_{start} \qquad ( 1 )$$

### Location Metrics: Per Trial:

The Ratio of Correct Movement (RCM) is defined by the number of velocity projections that are in the direction of the motor over the total number of significant movements:

$$RCM = \frac{{\sum }_{n = 1}^{T} f ( \text{?} ( n ) )}{{\sum }_{n = 1}^{T} f \text{?} ( \text{?} ( n ) \text{?} )} \text{?} 100 \% , \qquad ( 2 )$$

$$f ( \text{?} ( n ) ) = \begin{matrix}1 , & if \text{?} ( n ) > 20 mm / s \\ 0 , & otherwise\end{matrix}$$

$$\text{?} \text{indicates text missing or illegible when filed}$$

The Ratio of Accurate Touchpoints (RATP) is the number of touchpoints within 40 mm of the motor simulating anastomosis over the total number of touchpoints:

$$RATP = \frac{{\sum }_{n = 1}^{T} f ( TPD ( n ) )}{\text{?} TPD ( n )} \text{?} 100 \% , \qquad ( 3 )$$

$$f ( TPD ( n ) ) = \begin{matrix}1 , & if TPD ( \text{?} ) < 40 mm \\ 0 , & otherwise\end{matrix}$$

$$\text{?} \text{indicates text missing or illegible when filed}$$

Path Length is the total distance the index finger moves during palpation:

$$PL = \text{?} \qquad ( 4 )$$

$$\text{?} \text{indicates text missing or illegible when filed}$$

Per touchpoint: Distance to motor (TPD) is the distance from a touchpoint to the motor that is activated:

$$TPD = \text{?} \qquad ( 5 )$$

$$\text{?} \text{indicates text missing or illegible when filed}$$

### Force Metrics: Per Trial:

Touchpoints is the total number of touchpoints during palpation, defined by the number of peaks in the force profile of the subject and indicates the number of times there was applied pressure to the surface of the simulator bed during palpation.

Touch Frequency (Frequency) is the number of touchpoints recorded per second,

$$Frequency = \frac{Touchpoints}{Time} \qquad ( 6 )$$

### Per Touchpoint:

Touchpoint Time (TPT) is the dwell time, or the amount of time the subject spends at each touchpoint and is found by the width of the force peak found with MATLAB's findpeaks function.

Touchpoint Force (TPF) is the force applied at a touchpoint, F_{ind+mid} at trp, where t_{TP} is the timestamp of each of the peaks identified by the findpeaks function.

To the extent that any particular values for any of these metrics are articulated below, it is to be understood that these values are the results of a single study. Different studies may produce different values, and these values are only included as a proof of concept for the techniques described herein.

The median Time of palpation for experts and novices were 9.28 s and 15.7 s, respectively. The difference was significant according to the Mann-Whitney test with a p-value=0.001.

When observing the distance (TPD) of each touchpoint to the motor, experts demonstrated a median of 53.7 mm, while novices had a median of 85.0 mm. A Mann-Whitney test determined a significant difference with a p-value <0.001. The mean RCM of experts was 73.4% (SD: 18.5), and the mean RCM of novices was 65.2% (SD: 13.4). The differences were found to be significant using a two-sample t-test with a p-value=0.035. The mean RATP of experts was 38.7% (SD: 23.4), and the mean RATP of novices was 26.5% (SD: 19.8). A two-sample t-test found a p-value of 0.021, indicating a significant difference.

The mean expert Path Length was 992 mm (SD: 625), and the novices had a mean value of 1551 mm (SD: 816). A two-sample t-test showed a significant difference with a p-value=0.004.

The median number of Touchpoints of experts was 12, while the novices had a median of 22 Touchpoints. The Mann-Whitney test showed a significant difference with a p-value <0.001. The experts had a mean touch Frequency of 1.20 Hz (SD: 0.43) while the novices had a mean of 1.39 Hz (SD: 0.48). A two-sample t-test suggests a significant difference with a p-value=0.017. The difference in expert and novice median TPT was minimal but significantly different, with an expert median TPT of 0.394 s and novice median TPT of 0.339 s. A p-value of 0.002 was observed with a Mann-Whitney test.

The median TPF applied by experts was 0.738 N while the novices applied a median of 0.840 N. The Mann-Whitney test performed showed a significant difference with p-value <0.001.

Experts tended to palpate for shorter Time (p-value: 0.001). For location-based metrics, they palpated closer to the motor (lower TPD, p-value <0.001), have shorter PathLength (p-value: 0.004), higher Ratio of Correct Movement (RCM) (p-value: 0.035), and a higher Ratio of Accurate Touchpoints (RATP) (p-value: 0.021). Concerning force-based metrics, experts palpated at a lower Frequency (P-value: 0.017) and had fewer Touchpoints (p-value: <0.001) per trial but had higher dwell time at each touchpoint (TPT) (p-value: 0.002). They also applied less force at each touchpoint (TPF) (p-value: <0.001).

Additionally, a number of sub-tasks are also recognized for the cannulation simulation process. Some key events are critical for labeling sub-tasks during cannulation: the starting point of inserting the needle, the time when flashback is witnessed, and the moment of leveling out the needle. The insertion starting point (Tₛₜₐᵣₜ) can be described as the short pause right before inserting the needle into the skin surface. Since the short pause is used by participants to ensure the cannulation site is accurate, it not only marks the beginning of needle insertion, but also provides information on the participants' success in locating the optimal cannulation site from the palpation exam.

The needle flash point (T_{flash}) is defined as the time that participants first receive steady flashback. VIR stands for the filtered voltage reading from the IR detector and IRₜₕ is the voltage threshold for identifying whether the LED should be turned on. The leveling out point (Tₗₑᵥₑₗ) is described as when participants start to adjust and push the needle into a secured position after seeing flashback. Such movement can be found by locating local maxima and minima on the needle velocity profile v(t). Because participants need to advance the needle at an angle that is different from the one used for needle entry, it is expected that there is a local maximum on the finger force profile near this time point as well.

These values can further distinguish between expert, intermediate, and novice participants. For a general expert participant, the first flashback may occur around 19.34 s. There may be one major peak on the velocity profile representing a swift needle insertion around 19 s, right before the needle flash point. After flashback, another major peak may be seen on the velocity profile that is accompanied by an almost simultaneous peak on the force profile. This was produced by the subconscious movement of squeezing the wings of the needle to level out the needle angle and to push it into a secured position. The start of the leveling out movement is identified as the adjacent local minimum (19.95 s) before the major peak on the velocity profile. This clip of data describes a clean, swift, and efficient cannulation trial which is preferred during training. The number of major peaks on the velocity profiles are calculated based on the specific sub-task time segment of the cannulation procedure. For the expert participant, the number of extra movements before the needle flash point and after the leveling out point is very limited.

For an intermediate cannulation skill participant, at time 26.84 s the needle flash point is marked by the first sight of steady flashback. Before this point, there may be one major local maximum (Insertion Attempt 1) recognized on the velocity profile and only temporary flashback is observed. Although there is one local maximum of velocity after the needle flash point, the pattern may be considered to fit the insertion motion instead of needle leveling out. For this specific participant, the movement of leveling out is constantly skipped. Another discovery is that the number of local maxima of the velocity profile before the needle flash point is more sporadic (median=2).

For a cannulation trial by a novice participant, there may be no steady and constant flashback according to the IR voltage level, although there is a brief period in which the voltage of the IR detector indicates that the needle was in the AVF model. A brief flashback which goes away immediately after fits the pattern of needle infiltration. During this trial, the participant made three attempts and each attempt can be identified by combining needle tip depth, total finger force, and velocity profiles. Future effort is needed to systematically quantify these attempts. Compared to the examples of the other two participants, this was far from a successful cannulation.

There may also be additional objective metrics. A first metric, flash efficiency (eff), is designed to measure the efficiency with which participants obtained flashback during the whole task. The definition of flash efficiency is:

$$eff = \frac{{D}_{flash}}{{T}_{end} - {T}_{entry}}$$

The second metric, number of attempts (#att), counts the number of times the needle was pulled out and reinserted into the simulator after the first insertion. By default, the metric is instantiated at 1 since every trial has at least one attempt. A number greater than one-more than one insertion attempt—is undesirable per KDOQI guidelines.

The third metric, stb, is a binary indicator regarding attainment of stable flashback: 0 stands for failure to maintain stable flashback and 1 stands for the ability to maintain stable flashback. The criteria of stable flashback is that there is at least 2 seconds of flashback without any interruption until the end of a trial (i.e., when participants signal completion of trial to operators).

The last metric, number of infiltrations (#infil), estimates the number of times the needle perforated the vascular access by detecting the number of times flashback occurs and then disappears during the insertion process. Each occurrence of this behavior is counted as one infiltration. Per KDOQI guidelines, infiltration ought to be avoided because it often results in bruising and/or pain in addition to adverse clinical complications. Note that it is entirely possible for a subject to record multiple infiltrations but to ultimately obtain stable flashback.

Based on these metrics that measure specific aspects of cannulation outcome, one example of a composite metric for measuring overall success of cannulation can be derived. For instance, ocScore may be defined as:

$$ocScore = eff ( 1 - 0.25 ( l [ \# att > 1 ] + l [ \# infil > 1 ] + l [ stb ] ) )$$

While this is one example of a composite success score, when more metrics or variables are introduced to the system, the equation may be adjusted in order to account for the additional (or fewer) metrics.

The range of ocScore, in this particular instance, is [0,1], although other suitable ranges ([0, 10], [0, 100], [0, 50], or any other suitable range) could also be utilized with the techniques described herein. As per the KDOQI guidelines, perfect cannulation may be defined as one insertion attempt with stable flashback and no needle infiltrations while minimizing patient pain. Ideal cannulation may be expected when flash efficiency is at 100%, with only one insertion attempt, stable flashback, and no infiltration. However, due to the definition of flash efficiency, it is impossible to reach 100% efficiency. Effective cannulation, however, will yield ocScore values closer to 1. Note also that adverse events like infiltration and/or more than one insertion attempts are penalized in how ocScore is formulated, as these are errors that should be avoided. From a patient perspective, the quantities measured toward computing ocScore have implications for patient pain and comfort. That is, one or more adverse behaviors (e.g., more than one cannulation attempt) results in real pain and discomfort for the patient.

In addition to objective assessment of cannulation performance on the simulator, professionals may also monitor the assessment to provide a subjective assessment by expert nurses during cannulation on the simulator. These experts may provide subjective feedback to indicate whether the prediction using the sensors was correct. In instances where the techniques of this disclosure utilize machine learning, the experts may provide input to the system that adjusts either the weights, thresholds, or sensor calibration based on whether the expert feedback aligns with the predicted score.

Examples of additional metrics include statistical features with force and needle velocity. Using basic statistical features can help identify skills. Therefore, there may be upwards of three or more metrics in this category, including average absolute difference (AAD), average root sum of squared level (ARS), and average root square difference (ARD), alongside the average (Avg) and standard deviation (SD). All three metrics may be used, for example, on both velocity data and pinch force data.

Since unnecessary movement under the skin's surface may cause tissue damage, the metrics may further include features that describe cannulation behaviors when the needle is located under the skin's surface. Specifically, time (tᵤ), needle tip path length (PLᵤ), force integration (Flᵤ), and average needle angle (Angleᵤ) are included in this study.

A type of motion smoothness metrics, particularly built on the third derivative of location data, may be effective in quantifying motor learning. Since performing such a medical task is a type of motor learning, metrics like this may be valuable. Log dimensionless jerk (LDLJ) and spectral arc length (SPARC) may be produced based on needle tip velocity. Other than using location data, the roughness of pinch force data (Frgh) may also calculated based on finite difference (second-order backward).

To measure how close participants' estimates of point of maximum vibration were to the actual location, the system has defined a metric called accuracy, calculated as the distance (in millimeters) from the actual target location to reported fingertip location. For this, the lesser of the respective distances between actual location and index finger, and actual finger and middle finger is chosen. In general, the area of a fingertip is encompassed in a circular area with r=10 mm. Thus, any location estimates within a circular area of r=10 mm were considered as accurate estimates. Furthermore, location estimates that were marginally accurate may be defined as those outside the r=10 mm range but within a circular range of r=30 mm. Finally, estimates that were beyond the r=30 mm range were considered to be errors. It is to be noted that accuracy is an outcome, not process measure and, as such, measures the “how well” but not the “how” of palpation. As an accuracy-based outcome measure, accuracy may be defined as an indicator of whether subjects' final estimate of the location of the target was within 30 mm of the actual target. As an accuracy-based process measure, an error rate may be calculated, defined as the ratio of error frames to total movement frames within one trial.

From sensor location data, the velocity of finger-tip movement was calculated. From this, a metric was devised that determined whether, at any given instant, the participant was palpating towards or away from the actual location of stimulus. Such a metric may be useful for real time guidance and training of palpation skill. To compute the ratio of correct movement (RCM) Pₜₒₜ represents the total recorded path while the straight line P₀ connecting the current fingertip location and exact fistula location is the shortest path to complete the task. Recorded velocity Vᵣ is then projected onto the line P₀ to get a new vector Vₚ as the projected velocity at any time which indicates the “true” velocity towards the target. If the projected velocity is positive, test participants are moving in the correct direction (towards the point of vibration stimulus); otherwise, they are moving away from the target.

For each metric other than accuracy, a regression model (linear mixed model) was constructed with the metric as the dependent variable and each factor as independent variables in the form:

$${y}_{ij} = {μ}_{j} + {α}_{1} {l}_{i 1} + {α}_{2} {l}_{i 2} + {α}_{3} {l}_{i 3} + {residual}_{ij}$$

In this equation, yᵢⱼ is the estimated value; μis the participant specific mean;/, represents the status of one of the environment variables, including vibration type, vibration intensity and skin thickness. The level of significance was set to be 0.05.

The metric accuracy is a binary outcome and typical linear mixed modeling is not appropriate for such coarsely observed metrics. In light of this, for the analysis of the accuracy measures, a logistic generalized linear mixed model (GLMM) is employed, the GLMM consisting of two primary components: the linear predictor and a transformation, which can be written in the form:

$${η}_{ij} = {α}_{0 j} + {α}_{1} {l}_{i 1} + {α}_{2} {l}_{i 2} + {α}_{3} {l}_{i 3}$$

$${π}_{ij} = \frac{{e}^{{η}_{ij}}}{1 + {e}^{{η}_{ij}}}$$

where α₀ⱼ accommodates the participant specific differences in probability of being accurate by allowing each participant to have their own overall probability and the remaining αₖ terms correspond to treatment level effects on the probability of being accurate. The odds ratio is:

$$\text{?} = \begin{matrix}\text{?} \\ \text{?}\end{matrix}$$

$$\text{?} \text{indicates text missing or illegible when filed}$$

If the odds ratio is greater than 1 then it can be concluded that changing the design level from i to i′ increases the probability of being accurate; if it is less than 1 it decreases.

Additionally, in an ideal, smooth motion, acceleration may not have any discontinuities, as could be determined by the derivative of acceleration, jerk. This notion has served as the key idea for quantifying motion smoothness. However, computing “pure” jerk is too inconsistent to be used as a measure of motion smoothness. It was observed that jerk may be normalized as it depends heavily on movement duration and range of motion and that minimizing jerk is essential for smooth motion quantification.

This metric, known as dimensionless jerk, accounted for measuring the intermittency in motion regardless of its duration or amplitude. Intermittency in a discrete motion can arise from the lack of controlled movement, characterized by a period of deceleration preceding a point of acceleration, or can be due to finite periods of no motion from uncertainty. For a motion smoothness metric to be valid, it may have the following features: it may be dimensionless, monotonically responsive to motion, sensitive to changes in movement, and feasible for computation.

Another motion metric is spectral arc length. The metric is derived from the arc length of the amplitude of the frequency-normalized Fourier magnitude spectrum of the velocity profile. This metric is based on the observation that smooth hand movements will yield small magnitudes of low-frequency profiles, whereas “unsmooth” movements will yield large magnitudes of different higher-frequency profiles. The larger the magnitudes of different frequency movements are, the more the arc length of the profile increases. This idea is analogous to minimizing the cost function of jerk. Since this metric relies on analyzing motion via the frequency domain, it is more robust to noise and sensitive to changes in smaller movements. SPARC is being increasingly used to measure skilled or smooth motion, in which it consistently demonstrates strong correlations to skill between experts and novices.

While motion smoothness is able to offer accumulative metrics to quantify the overall level of skillfulness for the entire trial process, the frequency domain provides a different view in terms of motion characteristics. Discrete Fourier transform (DFT) and discrete cosine transform (DCT) has been used to assess surgical skills and proved to be highly effective. DCT and DFT may be applied to the time series of needle location, sensor rotation/orientation, and total pinch force. Because of the nature of human operation, only frequency components under 20 Hz were considered. Unlike studies that target longer surgical procedures, the techniques described herein may not apply a uniform length of sliding window to time series data. Both DCT and DFT were applied to data with the length of each trial. Therefore, it may be meaningless to compare the frequency components without the context of their corresponding frequencies. For each trial, the frequency components were ranked based on power (i.e., magnitude), then the ones that rank in the top 10 may be chosen to form a 20-element vector, which includes their power and corresponding frequency.

The metrics may further include functional data analysis (FDA) features. According to KDOQI guidelines, the needle entry angle should be set between 20 and 35 degrees. One single value of insertion angle is often used to summarize behaviors that last for a period of time. The actual needle path trajectory can be just as important as the angle in improving clinical outcomes. To further reveal how the needle angle can help deliver better outcomes, the techniques described herein may analyze the shape of the time series curves that represent the trajectory angle of the needle tip defined in. Just as skills are conventionally divided into three classes (novice, intermediate, and expert), the shape of the curves is grouped into three clusters. Each cluster stands for a general shape, reflecting a certain style of cannulation. A fuzzy C means clustering algorithm is applied in this functional data analysis via the scikit-fda python package. Each curve's clustering result is stored in a 1 by 3 vector, of which each element represents the membership probability.

The cannulation simulator consists of needle motion tracking, via electromagnetic sensors. Additionally or alternatively, including a video camera as well as an infrared detector/emitter allows the system to properly segment the cannulation phase precisely. When the needle tip makes contact with the simulator skin surface, the point of contact is considered as the skin puncture point. As the needle tip advances into fistula models, if the needle successfully gets into the fistula space, due to the infrared detector/emitter pair, users should see a red LED flashing by where users hold the needle wings as a sign of simulated blood flashback.

The IR-based needle tip location estimation system may estimate the needle tip location inside the fistula using a series of IR emitters actuated at different frequencies, placed inside of the fistula (either a curved or a straight fistula), and an IR detector integrated inside a needle used for the cannulation simulation. To indicate successful cannulation without any infiltration, when the needle is inserted correctly into the fistula, the detector picks up the emitted signal from the IR emitters and lights a red LED in the cannula to simulate a blood flashback.

The IR emitters may be actuated at unique frequencies so that, through proper signal processing, the voltage readings from the IR detector that is attached to the needle may present IR exposure from each emitter and, thus, estimate the needle tip location inside the fistula. In examples where there are four IR emitters (e.g., for a certain type of straight fistula model) that are actuated at 4 different frequencies, the frequencies may be set at frequencies that are varied enough for an IR detector to adequately determine a position based on the strength of the detected frequencies. For instance, the four frequencies may initially be set at 30 Hz, 340 Hz, 730 Hz, and 1200 Hz. These are just example frequencies, and the exact frequencies may vary depending on a number of factors, including a number of emitters, the specific type of electronic components, as well as whether the model is a straight or curved fistula model.

The various IR emitters may be embedded atop a filter circuit. A circuit design of the signal processing unit may use fourth order (e.g., two-second order cascaded) narrow bandpass filter circuits for each frequency to filter out the four frequencies of the IR emitters. Other circuit designs may be used in other examples, with the purpose of the circuit being to filter the four frequencies of the IR emitters. The circuit may also be designed with a gain of a certain amount (e.g., 10, or 20 dB) at the center frequency for each unit, for both positive and negative voltage power supply. In addition to, or in place of, hardware filtering, software methods may also be used for this purpose (e.g., implementing a 4th-order Butterworth filter in C++ code).

In examples where four IR emitters are utilized, the reading outputted by the IR detector sensor is passed through the filter circuit which yields four independent voltages corresponding to the amount of IR detected from each emitter. The four output voltages from the filter circuit are a function of the needle's proximity toward the four IR emitters.

IR detector output=f (IR emitter frequency, distance) Needle tip location=f (V_{RMS} from each filter)

In order to include the free motion of the needle in the X-direction, X-Y direction, X-Y-Z-direction, and roll motion of the needle, the dynamic controlled experimental setup for the system may be expanded to allow the motion of the needle in the X-direction, X-Y direction, X-Y-Z-direction, and roll motion of the needle.

Constraining the motion of the needle in Y-direction and Z-direction and only allowing dynamic motion of the needle in the X-direction, the calibration testing panel may consist of a line of IR emitters and a series of pre-defined regions (e.g., four regions for four IR emitters, or five regions for five IR emitters) based on the silicone fistula model. Also, based on the dimensions of the silicone fistula model, the maximum needle motion inside the fistula in the X-direction can be up to the full length of the fistula. Thus, the experimental setup may be based on the maximum distance the needle can travel in the X-direction inside the fistula. A user may dynamically move the needle in the X-direction along the experimental setup and collect voltage data throughout several trials from the filter circuit to build a voltage model for the X-direction. Thus, looking at the distribution of voltages from all four filters, the system may derive a set of hard threshold voltage reading values for the four specific pre-defined regions.

In some embodiments, one or more auxiliary sensors are employed to complement the infrared (IR) sensing system for measuring cannulation-related events and performance. The auxiliary sensors may include, for example, a motion tracking system, a force sensor, a hand tracking system, an inertial measurement unit, an external camera, or other modalities configured to capture kinematic or contextual information about the needle manipulation and surrounding environment. The controller may receive signals from these auxiliary sensors contemporaneously with the IR detections obtained via time-division multiplexing and may perform sensor fusion to improve event detection fidelity, spatial localization, and temporal resolution. By combining IR-derived tip detections with auxiliary sensor data, the system may enhance robustness against ambient light variations, occlusions, or material-specific attenuation characteristics and may provide more comprehensive training feedback.

Constraining the motion of the needle in the Z-direction and allowing dynamic motion of the needle in the X-Y direction, the user may dynamically move the needle in X-Y direction along the experimental setup. Again, based on the dimensions of the silicone fistula model, the maximum needle motion inside the fistula in Y direction can be equal to a diameter of the fistula model. The user may then dynamically move the needle in the X-Y direction along the experimental setup and collect voltage data throughout several trials from the filter circuit. Similarly, the system may derive a set of hard threshold voltage reading values for each of the four pre-defined regions from the distribution of voltages from all four filters, thus fine-tuning the four regions for dynamic needle motion in X-Y direction (for instances where there are four emitters and four regions).

Allowing dynamic motion of the needle in X-Y-Z direction, without roll motion of the needle, the user may dynamically move the needle in the X-Y-Z direction, along the experimental setup. Based on the dimensions for the fistula model, the maximum needle motion inside the fistula in Z-direction can be also equal to the diameter of the fistula model. Needle holder modules may be used on the experimental setup to incorporate the maximum distance the needle can travel in the Z-direction. The user may then dynamically move the needle in the X-Y-Z direction along the experimental setup and collect voltage data throughout several trials from the filter circuit. The system may derive a set of hard threshold voltage reading values for each of the four pre-defined regions the distribution of voltages from all four filters, thus fine-tuning the four regions for dynamic needle motion in X-Y-Z direction.

To include X-Y-Z-motion of the needle along with roll motion, on the same experimental setup, with the help of electromagnetic (EM) data from other sensors in the system, the system may find an approximate range of the roll motion (angle) and conduct the same experiment as for the dynamic motion of the needle in X-Y-Z direction along with roll.

Once the system is built with the hard-coded threshold values for each of the four regions, the system may implement an automatic iterative self-calibration code to adjust the threshold values for each of the regions. By performing a standard needle placement procedure, the actual needle positions may be used as inputs for the reference, to self-adjust the threshold values. The adaptive thresholding will also take into consideration the voltage pattern across all four filters during the dynamic motion of the needle. The performance of such sensors may be highly dependent on the external environment, such as room lighting. Having a self-calibrated adjustable code may help overcome the challenges of deploying the proposed device to wide variety of clinical settings.

The regions may be fine-tuned in an effort to eliminate overlapping regions in needle location estimation near the boundaries of the regions. The system may also be limited to roll and yaw motion of the needle for obtaining the desired accuracy of needle tip location estimation. To overcome this issue, the system may implement a boundary condition for the roll and yaw motion of the needle (e.g., in order to obtain the desired accuracy of needle tip location estimation, the roll motion should be limited 60 degree)

During the needle insertion process, the needle insertion angle is calculated based on the location of the needle tip over a grid of time points, which forms a time series. Each needle tip location is mathematically connected to the skin puncture point to form a vector, which is then used to calculate the angle between itself and the skin surface normal vector. Using such a calculated angle and subtracting from 90° should result in the proper needle insertion angle. Observations having high scores on this first principal component tend to have flatter-than-average angles (lower values in degrees), especially avoiding steepness (higher values in degrees) during a key period one-fourth of the way through the insertion. A slightly slower rate of angle decreasing is possibly explained by inefficient needle trajectory, and brings a higher chance of inserting the needle too deep. Assuming that a lower angle allows the participant to more safely control how deep the needle goes, lower angles may be preferable. In both cases, the majority of the angles stay above 45° through the length of the trial. Although it is possible for the needle to travel in such a fashion and still avoid infiltration, the chance of infiltration and failure to secure the needle in a safe location drastically increases with such a steep angle. Additional dangerous behaviors include when the needle tracking graph exhibits a strange oscillating pattern while maintaining a reasonable angle. The strange oscillating pattern can be interpreted as a “digging” motion. When participants cannot achieve stable flashback, some may choose to tilt the needle up and down or to retract the needle halfway out for an extra attempt in order to find the secure location. During this process, not only is the chance of unnecessary tissue damage severely increased, but also patients are put in great danger of major infiltration.

Magnitude of the insertion angle curves reflects the average insertion angle, and slope or shape of the curves delivers a similar message about the derivative of insertion angle, but they both display more details about timing and fluctuations within each trial. When used in training programs, instead of offering trainees a simple measure of average insertion angle by an expert instructor, a future training system could automatically compare users' insertion angle to a specific preferred style. The visual presentation of insertion angle curves during the whole task can help instructors teach trainees how to be safe beyond just keeping the initial insertion angle within the guidelines. Whether it is a problem of high insertion angle or “digging”, trainees can pay attention to the particular areas that need improvement. For example, “digging” can be caused by confusion about the actual location of the fistula, so instructors can remind trainees to take more time and effort in palpation before inserting the needle. Using FDA, a simulator-based training system can analyze motion data seamlessly with objective assessment on how to improve cannulation.

Needle “shaking” may also reflect the smoothness of needle insertion angle during the cannulation. To better quantify the insertion performance during an attempt, the angle-based metrics was extracted in two main scales (the whole segment(S) and the sub-segments of the attempt if having flashback). The sub-segments of an attempt included before flashback (S₁) and after flashback (S₂). For the needle “shaking” (LDLJ(α)), all its metrics are significantly correlated with outcome metrics. They are negatively correlated with the number of infiltration (num_infil), while positively correlated with flash ratio (FR), flash efficiency (FE), and outcome score (ocScore). The absolute correlation coefficients between needle “shaking” metrics and outcome metrics based on attempts were from 0.2067 to 0.4462. And the absolute correlation coefficients based on trials were from 0.1896 to 0.3804. For the needle “digging” (α′), only its metrics on the whole attempt(S) and before flashback (S₁) show significantly correlated with outcome metrics. They are positively correlated with the number of infiltration, but negatively correlated with the other three outcome metrics. The absolute correlation coefficients between needle “digging” metrics and outcome metrics were from 0.1319 to 0.2457 based on attempts and from 0.1480 to 0.2400 based on trials. For the average insertion angle(α), only its metrics are significantly correlated with the flash efficiency and outcome score. The correlation coefficients are from −0.2303 to −0.0863.

Hemodialysis cannulation (HDC) includes the following four steps:
Step 1. Identify the point of needle insertion using visual inspection and palpation of the AV fistula;
Step 2. Insert the needle into the fistula at a 20-35° angle with the bevel facing upward;
Step 3. Rotate the needle 180° to prevent back-wall infiltration after blood “flashback” (done in certain conditions); and
Step 4. “Level out” and advance the needle for securing it.

Of the four steps mentioned above, the first pertains to determining where to insert the needle, whereas the last three pertain to the needle insertion technique itself. Consequently, for analyzing needle insertion skill, the process may be divided into phases as follows: “Insertion phase” (Phase 1), “Rotation phase” (Phase 2), and “Leveling and forwarding phase” (Phase 3), respectively. These phases are identified by four events: needle tip entering the skin surface, pausing insertion before rotating, finishing needle rotation, and completing advancing the needle. The four events are simultaneously recorded by both the camera outside the simulator and the electromagnetic tracker. There may be a time delay between the synchronized camera video and the EM tracking data when detecting the same event, because of different sampling frequencies. It may be assumed that the time delay between the camera and EM tracker is constant. The four event time points with respect to camera video (CT) were noted by manual inspection done by the authors during data processing. The time delay (t_{delay}) was calculated by averaging the time differences between a first camera and the EM sensor at the first two events. Subsequently, the corresponding time points in the EM data stream, denoted EMT, at the last two events were obtained by subtracting the time delay (t_{delay}) from the corresponding time points with respect to the camera video (CT) to extract the phase specific motion metrics of the needle tip.

In order to perform cannulation workflow segmentation and metrics extraction, three spatial planes were defined as the skin surface plane, the fistula plane and the cross sectional plane of the fistula. The skin surface plane was determined by fitting the equation of a plane with several point positions measured on its surface using the EM tracker. The fistula plane was determined by fitting any three of the four measured vertices (Pₐ, P_{b}, P_{c}, and P_{d}) of its plane. The axial line (Pₑ P_{f}) of the fistula was determined by calculating the middle points on its short sides. The cross sectional plane was calculated as perpendicular to the fistula plane with Pₑ as its center.

The needle motion metrics extracted from sensor data can be used to quantify cannulation insertion skills. The very first step for a successful cannulation is to find the orientation of the fistula correctly through palpation. Two metrics, the start point accuracy and the lateral angle of the needle, indicate whether the location and the orientation of the fistula are found correctly during the procedure. During needle insertion, other process metrics are computed that assess the subject's technique during cannulation, including completion time, path length traversed by the needle tip, average velocity, average insertion angle, and average rate of change of insertion angle. Simulator-based outcome metrics measure the outcome of the HDC task on the simulator, that is, whether infiltration occurs during or after the task. Two outcome metrics, infiltration risk and final needle tip position, are computed.

Needle location features may also be utilized. a₀/a₁/a₂ may be the distance between the projected needle tip position (P′) and the fistula's middle axis, which measures how far the needle tip position is from the safest path. β₀₁/β₁₂/β₀₂ may be the angle between the needle tip trajectory and its perfect insertion trajectory, which measures how much the insertion motion deviates from the ideal path. dM₀/dM₁/dM₂ may be the distance between the needle tip position and the motor location, with the motor used to mimic the anastomosis in this experiment, which measures how far the needle tip is from anastomosis.

The metrics may also include threshold selection features. These binary features are produced based on whether a certain behavior has exceeded a certain threshold. For instance, if a subject pauses for an extended time between starting the insertion and seeing first flashback, it is reasonable to believe it is a sign of confusion relating to a lower skill level. When the magnitude of some metrics exceeded a certain quantitative threshold, it is considered a change in quality. These binary features are pairwise multiplied by other features for behavior selection.

Examples of each of the above metrics are shown in the below Table 1:

TABLE 1
Feature Definitions

| | Feature | | |
|---|---|---|---|
| Category | Variable | Equation/Criteria | Interpretation |
| Statistical features | AAD(V/F) | $\frac{{1}^{L - 1}}{{L}_{j = 0}} abs ( x ( j ) - x )$ | The average absolute difference between the value |
| | | | of each element of |
| | | | each variable and |
| | | | the mean of all |
| | | | elements in that |
| | | | variable (L denotes |
| | | | the length of the |
| | | | data) |
| | ARS(V/F) | $\frac{{1}^{\sqrt{L - 1}}}{{L}_{j = 0}} {( x ( j ) )}^{2}$ | The average of the root sum of squares level of |
| | | | each signal |
| | | | variable. |
| | ARD(V/F) | $\frac{{1}^{\sqrt{L - 1}}}{{L}_{j = 0}} ( x ( j ) - \overline{x} )$ | The average difference between the value of each |
| | | | element of each |
| | | | variable and the |
| | | | mean of all |
| | | | elements in that |
| | | | variable. |
| Cannulation behavior | tᵤ | ${t}_{u} = {}_{j = 0}^{L - 1} t ( j ) U ( j )$ | The total duration of needle tip |
| | | $U ( j ) = \begin{matrix}1 , & if z ( j ) < {z}_{surface} \\ 0 , & if z ( j ) > {z}_{surface}\end{matrix}$ | moving under the skin surface. |
| | PLᵤ | ${}_{j = 0}^{L - 1} \sqrt{{( {x}_{L + 1} - {x}_{L} )}^{2} + {( {y}_{L + 1} - {y}_{L} )}^{2} + {( {z}_{L + 1} - {z}_{L} )}^{2} U ( j )}$ | The total needle tip path length while |
| | | | moving under the |
| | | | skin surface. |
| | FIᵤ | ${FI}_{u} = {}_{{t}_{entry}}^{{t}_{end}} f ( t ( j ) ) u ( j ) dt$ | The integrated pinch force strength |
| | | | while needle tip |
| | | | moving under the |
| | | | skin surface. |
| | Angleᵤ | | The average |
| | | | needle angle while |
| | | | needle tip moving |
| | | | under the skin |
| | | | surface. |
| Motion smoothness | LDLJ(V) | $LDLJ ( V ) = - ln \vert \frac{{T}^{5}}{{PL}^{2}} {}_{{t}_{entry}}^{{t}_{end}} \frac{{( {d}^{3} X )}^{2}}{{dt}^{3}} \vert$ | The natural log of jerk integrated and squared. |
| | SPARC(V) | $SP ARC ( V ) = {}_{0}^{{r}_{ω c}} {( \frac{1}{{ω}_{c}} )}^{2} + {( \frac{dV ( ω )}{d ω} )}^{\frac{1}{2}} d ω$ | The arc length of the Fourier transform of the |
| | | | velocity profile. |
| | Frgh | $Frgh = {}_{j = 2}^{L} {( f ( j ) - 2 f ( j - 1 ) + f ( j - 2 ) )}^{2}$ | The accumulated square of second- |
| | | | order derivative of |
| | | | pinch force. |
| Threshold | binStop | Whether there is a stop/hesitation before reaching | Separating motion |
| selection | | to first flashback. | with obvious |
| features | | | interruption from |
| | | | uninterrupted trials. |
| | binSteer | Whether the fast needle steering motion (detected | Separating aimless |
| | | by the change of needle orientation) has exceeded | needle digging trial |
| | | 50 frames in total, per trial. | from needle |
| | | | insertion with clear |
| | | | target. |
| | binFpks | Whether there has been more than 3 major peaks in | Identifying a certain |
| | | pinch force data, per trial. | cannulation style |
| | | | that applies more |
| | | | sudden force to the |
| | | | needle. |
| | bina₀ | Whether a₀ is greater than 10 mm | Identifying clear |
| | | | wrong judgement of |
| | | | fistula location. |
| | bina₂ | Whether a₂ is greater than 5 mm | Identifying clear |
| | | | danger of |
| | | | infiltration. |
| | binβ₀₂ | Whether β₀₂ is greater than 20 degrees. | Identifying insertion |
| | | | style that is very |
| | | | susceptible to |
| | | | infiltration. |

During experimentation, certain of these metrics may prove to have a stronger positive correlation to cannulation success, such as binStop, ARD (F)+binStop, clti+binFpks, LDLJ (V), ARD (F), and SPARC (V), although further experimentation may prove different metrics have a stronger positive correlation with cannulation success. For example, binStop is the most impactful feature, and it can be interpreted as showing signs of stop or hesitation after inserting the needle into the simulator before seeing flashback. Another example is that LDLJ (V) ranks highly on the list of features that positively impact the score. The value of LDLJ (V) is always negative and the closer it is to zero, the higher motion smoothness it reflects. Since LDLJ (V) represents the motion smoothness measured by needle tip velocity, it may be fair to interpret any sudden needle tip jerk as obstructing a better outcome. Such results further validate the power of third-derivative based motion smoothness metrics in terms of assessing medical task performance. Another discovery that is consistent with opinions from clinicians is that keeping the needle trajectory angle low with caution is important to gain preferred outcomes.

Other than motion based metrics, pinch force may impact outcome. The large positive coefficient associated with ARD (F) may appear to reinforce discussions within the dialysis community about how more experienced clinicians can teach novices about using a light-handed style rather than a heavy-handed style. Because higher ARD (F) implies for a higher average difference between the value of each element and the mean of pinch force, higher ARD (F) values can be associated with the style of applying high pinch force with focus only at moments, instead of constantly applying high pinch force all the time, which often results in applying too much force through the needle to patients. This quantitative metric can be a teaching tool for instructors who wish to pass on a more light-handed cannulation style to trainees. Because the features that matter the most to outcomes have been identified and measured on a continuous objective scale, it enables future training to emphasize more on such features with comparable references and eventually achieve intuitive training. These values can be incorporated into a training interface, which provides constructive feedback to users. For instance, when users are informed of where their performance features rank among the test population and the preferable values for each feature, they can improve on specific aspects of the cannulation task on the simulator through practice. Therefore, users can learn from trial-based instructions on how to achieve a better score, with reduced cost of manual power and reduced workload from instructors.

Similarly, some metrics may prove to have a stronger negative correlation to cannulation success, such as PLᵤ, PLᵤ+binStop, FLᵤ+binStop, Avg (V), PLᵤ+binFpks, Angleᵤ, and SD(V), although further experimentation may prove different metrics have a stronger positive correlation with cannulation success. As such the model may use particular weights to account for the positive and negative correlations. In examples where the model is a machine learning model, as more data becomes available and more certainty is gathered as to what metrics positively and negatively correlate with cannulation success, the machine learning model may adjust the weights to account for the updated information.

As such, it is clear that certain metrics, which are ultimately determinable based on measurements performed by the various sensors described herein, indicate a particular skill level of a medical professional performing a cannulation. With a baseline of initial measurements, such as those described above, the system described herein may analyze a particular user's cannulation simulation and provide an assessment as to where that user falls on the spectrum between (and outside of) expert and novice.

In accordance with the systems and methods described herein, physical cannulation simulator system 100 is configured to simulate the process of cannulation for medical training purposes. System 100 may integrate a physical cannulation simulator 104, a cannulation needle 106, and various sensor subsystems (e.g., optical hand tracking sensor system 112, pressure sensor system 114, electromagnetic position sensor system 118, external camera system 122) to provide a realistic and interactive training environment. For example, physical cannulation simulator system 100 may simulate anatomical structures and needle interactions to enable a user to practice and refine cannulation skills in a controlled setting.

In some examples, hand 102 represents the user's hand interacting with cannulation needle 106 during operation of physical cannulation simulator system 100. Hand 102 may be positioned by the user to manipulate needle 106 relative to simulator 104. Optical hand tracking sensor system 112 may track hand 102 to provide data on hand movements and positioning, wherein the data is used to enhance simulation realism and to generate feedback on user technique.

Accordingly, cannulation needle 106 is an instrumented medical needle configured for insertion into physical cannulation simulator 104. Cannulation needle 106 may include needle sensors 116, which may comprise an internal fiber optic waveguide extending to or near the distal tip. The internal fiber optic waveguide may convey incident light from the distal tip to a photodetector located in control box 108 or computing device 110. Needle sensors 116 may detect vessel entry events and relay corresponding feedback to the user, for example, by processing light signals emitted by infrared emitters 120.

Examples of pressure sensor system 114 include any hardware configured to detect pressure exerted during the cannulation process. Pressure sensor system 114 may be associated with cannulation needle 106 to provide data on force applied by the user, which is significant for simulating realistic needle insertion scenarios. The force data may be processed by computing device 110 to evaluate user technique and generate performance feedback.

In some examples, needle sensors 116 are integrated into cannulation needle 106 and are configured to detect light signals emitted by infrared emitters 120. Needle sensors 116 may include an internal fiber optic waveguide that conveys incident light from the distal tip of the needle to a photodetector in control box 108. Needle sensors 116 may be operable to detect vessel entry events and determine needle position and orientation relative to physical cannulation simulator 104, wherein collected data is processed by control box 108 to provide feedback to the user.

In accordance with the present disclosure, physical cannulation simulator 104 is a modular platform designed to simulate anatomical structures, such as a peripheral vein, an arteriovenous fistula, or a synthetic graft. Physical cannulation simulator 104 may include an array of infrared emitters 120 positioned beneath the surface of the simulator to generate signals 124 detectable by cannulation needle 106. Simulator 104 may be configured to receive modular anatomy units through a common physical interface that may include magnetic couplings to ensure repeatable spatial alignment, thereby providing a realistic environment for practicing cannulation techniques.

Examples of infrared emitters 120 include any optical emitters arranged in a grid pattern beneath physical cannulation simulator 104. Infrared emitters 120 may be configured to emit light signals detectable by needle sensors 116 of cannulation needle 106. Control box 108 may sequence infrared emitters 120 via time-division multiplexing based on calibration parameters and geometry information stored in the embedded memory module of the modular anatomy unit. Infrared emitters 120 play a significant role in determining needle position and orientation and in detecting vessel entry events.

Accordingly, computing device 110 is communicatively coupled to control box 108 and other sensor subsystems within physical cannulation simulator system 100. Computing device 110 may process data collected from needle sensors 116, infrared emitters 120, electromagnetic position sensor system 118, and external camera system 122. Computing device 110 may run a digital twin software model to calculate parameters such as stress, deformation, shear force, and fluid dynamics. Furthermore, computing device 110 may provide a user interface for displaying computed metrics, including outcome metrics, process metrics, and motion-based metrics.

In some examples, IR data acquired from the IR sensing system is used to estimate the outputs of one or more other sensors, such as motion or force sensors. The controller may implement model-based or data-driven inference techniques that map temporally distinct IR detections, emitter contributions, and geometry-constrained tip trajectories to approximate kinematic signals (e.g., acceleration, velocity, jerk) and interaction forces (e.g., axial insertion force, lateral wall contact force). In this approach, the controller leverages anatomy-specific calibration parameters and geometry information stored in the embedded memory of the modular vessel unit to constrain the estimation problem and reduce ambiguity, thereby generating surrogate signals that approximate those produced by more expensive or infeasible hardware sensors. This capability advantageously reduces system cost, complexity, and integration burden while maintaining measurement coverage for training scenarios that benefit from motion or force feedback.

In some examples, control box 108 acts as the central processing hub for physical cannulation simulator system 100. Control box 108 may be communicatively coupled to needle sensors 116, infrared emitters 120, and other sensor subsystems. Upon connection to a modular anatomy unit, control box 108 may automatically read calibration parameters and geometry information from the unit's embedded memory module. Control box 108 may process signals 124 from needle sensors 116 and infrared emitters 120 to determine vessel entry events and provide corresponding feedback to the user, for example, by activating visual indicators or alerts.

Examples of electromagnetic position sensor system 118 include any hardware configured to track position and orientation of cannulation needle 106 relative to physical cannulation simulator 104. Electromagnetic position sensor system 118 may provide additional data for sensor fusion, enabling control box 108 to determine precise metrics such as needle trajectory and insertion velocity, thereby enhancing simulation accuracy.

In accordance with the foregoing, external camera system 122 is positioned above physical cannulation simulator 104 and is configured to capture visual data during the simulation. External camera system 122 may provide additional data for sensor fusion, which may be processed by computing device 110 to determine metrics such as needle events and location. In some examples, external camera system 122 may also monitor the user's technique and provide feedback.

Accordingly, optical hand tracking sensor system 112 is positioned above physical cannulation simulator 104 and is configured to track movements and positioning of hand 102 during the simulation. Optical hand tracking sensor system 112 may provide data on hand movements, which may be processed by computing device 110 to evaluate user technique and provide feedback, thereby enhancing simulation realism.

Examples of signals 124 include any data transmitted between the various components of physical cannulation simulator system 100. Signals 124 may include light signals emitted by infrared emitters 120, data collected by needle sensors 116, and processed information transmitted by control box 108 to computing device 110. Signals 124 play a significant role in system operation and in providing feedback to the user.

In some examples, frame 126 provides structural support for physical cannulation simulator system 100. Frame 126 may support components such as optical hand tracking sensor system 112 and external camera system 122, ensuring their proper positioning relative to physical cannulation simulator 104. Frame 126 may be designed to maintain spatial alignment of components, thereby contributing to simulation accuracy and reliability.

In some examples, the estimated outputs derived from IR data are incorporated into cannulation event detection logic and downstream metric computations. The controller may use the inferred motion and force signals, in combination with IR-derived tip position and orientation, to detect events such as initial skin puncture, vessel wall contact, vessel entry, and infiltration. For example, a characteristic pattern in the estimated force profile synchronized with IR tip localization near the vessel boundary may indicate a wall contact event; a subsequent signature change and geometric transition into the lumen may confirm vessel entry. Similarly, a rapid decrease in estimated axial force and tip trajectory crossing a predefined exterior boundary may indicate infiltration. The controller may compute process metrics, motion-based metrics, and event-based metrics using both the IR detections and the estimated sensor outputs, thereby providing trainees with comprehensive performance assessments without requiring dedicated electromagnetic motion sensors or high-cost force transducers.

In certain implementations, the controller continuously refines the estimation models during operation by comparing auxiliary sensor signals, when available, with IR-derived estimates to update model parameters and improve accuracy over time. When auxiliary sensors are absent or disabled, the controller may rely solely on IR-based estimation constrained by module-specific calibration and geometry to produce motion and force surrogates with sufficient fidelity for training purposes. In all cases, the controller may present the computed metrics and detected events via a user interface and, where applicable, generate physical feedback through visual indicators or buzzers to reinforce correct technique and highlight deviations. This IR-centric estimation framework enables a scalable and adaptable training system that maintains high-quality feedback while minimizing reliance on costly or impractical sensing hardware.

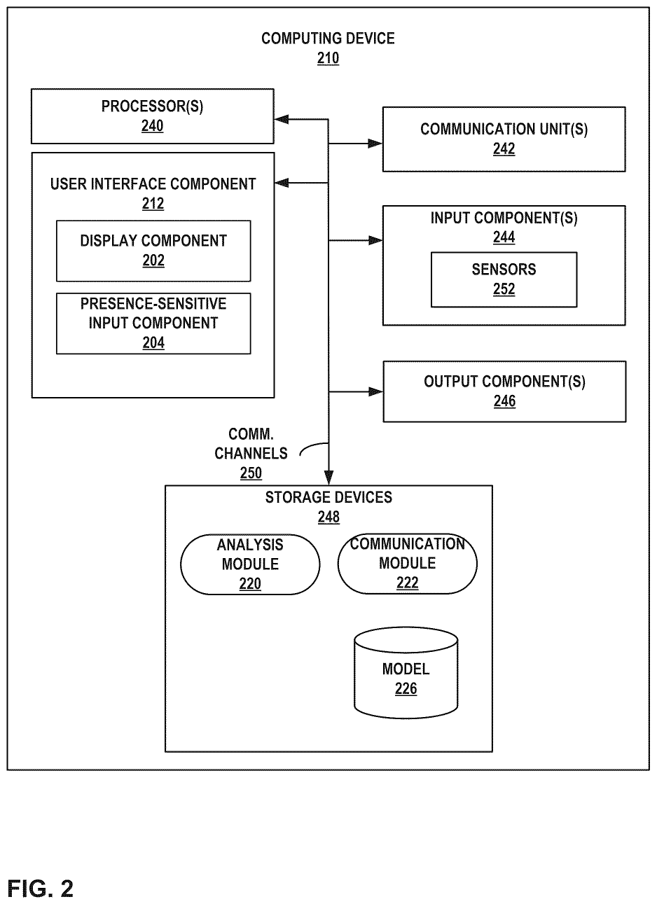

FIG. 2 is a block diagram illustrating an example computing device configured to receive data measured by sensors and analyze that data to ultimately determine a performance metric for a user performing a physical cannulation simulation, in accordance with one or more aspects of the techniques described in this disclosure. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include analysis module 220, communication module 222, and model 226.

One or more processors 240 may implement functionality and/or execute instructions associated with computing device 210 to calculate a metric descriptive of either an absolute performance or a relative performance for a user during a physical cannulation simulation. That is, processors 240 may implement functionality and/or execute instructions associated with computing device 210 to analyze a user's performance with respect to a threshold using various metrics indicative of a successful cannulation procedure.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to analyze sensor data to determine a metric of a user's absolute performance or the user's relative performance during a physical cannulation simulation.

Analysis module 220 may execute locally (e.g., at processors 240) to provide functions associated with calculating a metric of a user's performance during a physical cannulation simulation. In some examples, analysis module 220 may act as an interface to a remote service accessible to computing device 210. For example, analysis module 220 may be an interface or application programming interface (API) to a remote server that analyzes sensor data to asses a user's skills during a physical cannulation simulation.

In some examples, communication module 222 may execute locally (e.g., at processors 240) to provide functions associated with communicating with various sensors and output devices. In some examples, communication module 222 may act as an interface to a remote service accessible to computing device 210. For example, communication module 222 may be an interface or application programming interface (API) to a remote server that receives data generated by and transmitted by the sensors, as well as communicates with various output devices.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, and model 226. Storage components 248 may include a memory configured to store data or other information associated with modules 220 and 222, and model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, communication module 222 may operate to facilitate data exchange between the medical training simulator's base unit 1110 and external computing devices or systems 210. Communication module 222 may be communicatively coupled to controller 900 to enable transmission of correlated detections and processed sensor data for further analysis or integration into advanced computational models 226. For example, communication module 222 may transmit signals 124 derived from the light detection system of instrumented medical needle 801, together with ancillary sensor outputs, to an external computing device 110 executing a digital twin software model 226. Accordingly, the external computing device 110 may process the transmitted signals 124 to derive parameters including stress on the modular anatomy unit 420, deformation of simulated tissue, shear force, and fluid dynamics.

Upon receipt of a modular anatomy unit 420 at the simulator base 410, communication module 222 may facilitate transmission of anatomy-specific calibration parameters and geometry information read by controller 900 from embedded non-volatile memory module 430. Communication module 222 may ensure that temporally distinct illumination patterns generated by array of light emitters 120, sequenced via time-division multiplexing, are accurately correlated with detections from the light detection system of instrumented medical needle 801. If correlation of emitter contributions and detection events is successful, analysis module 220 may compute needle position and orientation based on the correlated detections; otherwise, communication module 222 may request retransmission or re-sequencing of illumination patterns 120.

Examples of data transmitted by communication module 222 include fused infrared measurements 810 and outputs from additional physical sensors, such as motion tracking systems 112 or external cameras 122. Communication module 222 facilitates sensor fusion by linking physical measurements from the infrared system 810 to data streams from other sensors and delivering the fused data to the external computing device 110 for advanced analysis.

In accordance with the techniques described herein, analysis module 220 may be tasked with processing and analyzing data received from the sensor system 252, including the light detection system of instrumented medical needle 801 and supplementary sensors such as motion tracking systems 112 or external cameras 122. Analysis module 220 may perform sensor fusion by combining light detection signals with auxiliary sensor data to determine metrics such as needle trajectory, insertion velocity, and precise needle events. For each detected event, analysis module 220 may compute needle position and orientation, thereby providing accurate, reliable feedback for the user.

Analysis module 220 may utilize calibration parameters and geometry information stored in embedded non-volatile memory module 430 of the modular anatomy unit 420 to process correlated detections from the light detection system. In particular, analysis module 220 may identify temporally distinct illumination patterns generated by array of light emitters 120, sequenced via time-division multiplexing, and determine individual emitter contributions. Thereafter, analysis module 220 may compute needle position and orientation and identify specific needle events such as vessel entry or infiltration.

In addition, analysis module 220 may integrate processed data from communication module 222 for transmission to an external computing device 110 running the digital twin software model 226. Accordingly, the digital twin software model 226 may calculate parameters such as stress on the modular anatomy unit 420, deformation of simulated tissue, shear force, and cardiovascular fluid dynamics. Analysis module 220 thus ensures that processed data is accurate and comprehensive, enabling high-fidelity simulation of the physical environment.

Analysis module 220 may further support an infiltration detection system integrated into computing device 210. By utilizing light detection data and calibration parameters, analysis module 220 may determine infiltration events when the needle tip is detected outside a predefined boundary of the modular anatomy unit 420. Upon detection of an infiltration event, analysis module 220 may activate an alert sequence, which may include deactivation of the flashback indicator 811 and activation of a buzzer 930 to provide feedback to the user.

Moreover, analysis module 220 may monitor positions of multiple instrumented medical needles 801 concurrently during a single cannulation trial. For each needle, analysis module 220 may correlate detections to determine respective needle events and may provide visual indicators, such as light-emitting diodes 811, to signal vessel entry events. Analysis module 220 may also selectively activate different illumination patterns of array of light emitters 120 based on calibration parameters and geometry information stored in embedded memory module 430, thereby optimizing sensor readings for the specific modular anatomy unit 420 in use. For example, when the modular anatomy unit 420 comprises a lung model, analysis module 220 may activate clusters of light emitters in biopsy regions to enhance location accuracy rather than general needle detection events. Similarly, when the modular anatomy unit 420 comprises a spine model, analysis module 220 may activate light-emitter arrays arranged to model the spinal cord, thereby enabling detection of needle entry into the spinal canal and simulation of an epidural space.

In some instances, analysis module 220 may estimate outputs of one or more additional sensors including at least one of a motion sensor and a force sensor by applying model-based or data-driven inference techniques that map temporally distinct infrared detections, identified emitter contributions, and geometry-constrained needle tip trajectories to generate surrogate kinematic signals and interaction force signals, the estimating being performed based on the calibration parameters and geometry information read from the embedded non-volatile memory.

In some instances, analysis module 222 may further estimate spatial information of the instrumented medical needle from sensor data gathered by one or more additional sensors to generate a prediction of cannulation performance based on the positioning of the instrumented medical needle or a user posture relative to the vessel module, the sensor data including user behavior prior to insertion of the instrumented medical needle.

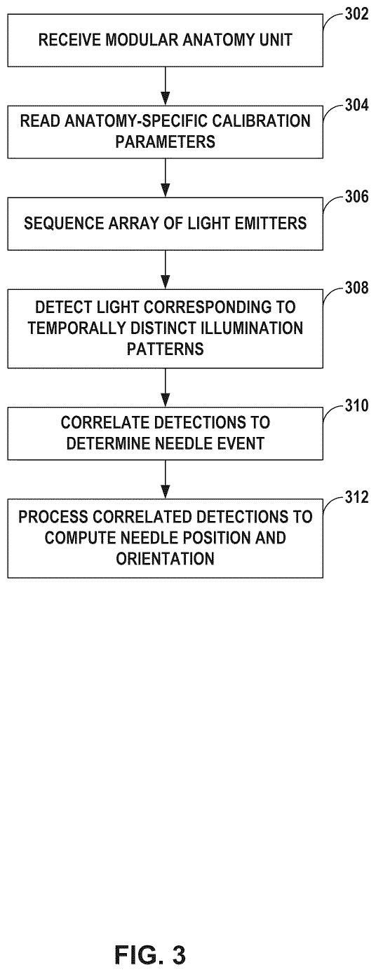

FIG. 3 is a flow chart illustrating an example mode of operation. The techniques of FIG. 3 may be performed by one or more processors of a computing device, such as system 100 of FIG. 1 and/or computing device 210 illustrated in FIG. 3. For purposes of illustration only, the techniques of FIG. 3 are described within the context of computing device 210 of FIG. 3, although computing devices having configurations different than that of computing device 210 may perform the techniques of FIG. 3.

In accordance with the techniques of this disclosure, At step 302, communication unit(s) 242 establish a data link over communication channels 250 with an embedded non-volatile memory of the received modular anatomy unit. Input component(s) 244 detect coupling of the unit to the simulator base, and sensors 252 may confirm physical alignment. Communication module 222, executing on processor(s) 240 and stored within storage devices 248, initiates a handshake to identify the modular anatomy unit and to ready downstream processing by analysis module 220.

At step 304, processor(s) 240, via communication unit(s) 242 and communication module 222, read anatomy-specific calibration parameters and geometry information from the embedded non-volatile memory of the modular anatomy unit and store them in storage devices 248. Analysis module 220 loads the parameters into working memory for use in emitter sequencing, detection correlation, and event computation.

At step 306, processor(s) 240 execute analysis module 220 to define a plurality of temporally distinct illumination patterns based on the calibration parameters and geometry information. Communication module 222 transmits control messages through communication unit(s) 242 to the simulator base to drive an array of light emitters using time-division multiplexing, thereby generating the temporally distinct illumination patterns.

At step 308, sensors 252 acquire signals from a light detection system of an instrumented cannulation needle while the needle is manipulated relative to the modular anatomy unit. The signals are received by input component(s) 244 and conveyed over communication channels 250 to processor(s) 240. Communication module 222 time-stamps the detections relative to the active illumination pattern identifiers so that subsequent correlation can associate detections with emitter contributions.

At step 310, analysis module 220, executed by processor(s) 240, correlates detections received via input component(s) 244 to the temporally distinct illumination patterns commanded via communication unit(s) 242. Using the stored calibration parameters and geometry information in storage devices 248, analysis module 220 identifies emitter contributions and determines at least one needle event, such as a vessel entry event or an infiltration event. Output component(s) 246 may be driven to generate immediate feedback signals indicative of the determined event.

At step 312, analysis module 220 processes the correlated detections with the calibration parameters and geometry information to compute a needle position and orientation associated with the at least one needle event. The resulting metrics, which may include trajectory and insertion velocity, are made available to user interface component 212 for presentation on display component 202 and/or presence-sensitive input component 204, and may also be packaged by communication module 222 for transmission via communication unit(s) 242 to external devices, including a digital twin model stored as model 226 within storage devices 248 or hosted remotely.

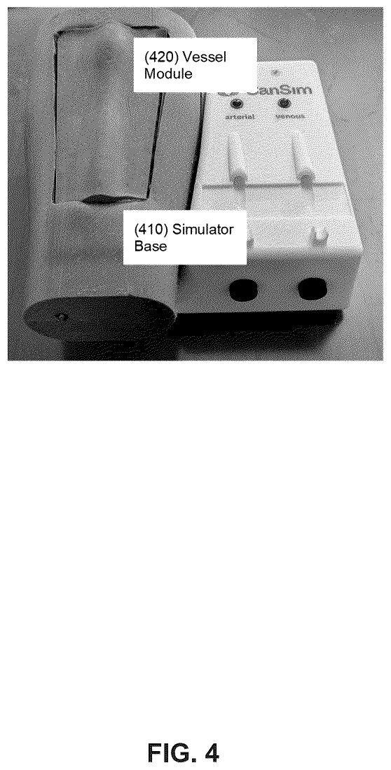

FIG. 4 is a photograph illustrating an example simulator base and vessel module configured for modular anatomy unit integration, in accordance with the techniques described herein. Simulator base 410 may serve as the foundational platform for a medical training simulator system. For example, simulator base 410 is configured to mimic the physical structure of a biological tissue, such as an arm, and to provide the necessary support and alignment for vessel module 420. In particular, simulator base 410 may include a common physical interface that facilitates the secure attachment and repeatable spatial alignment of vessel module 420. For instance, the common physical interface may comprise fixed magnets 412 that interact with magnetic positioning aids 422 on vessel module 420 to ensure precise alignment, which is important for accurate functioning of the sensor systems, including the array of light emitters 120 and an instrumented needle 801.

In some examples, simulator base 410 houses several integrated components that enhance both the realism and functionality of the simulation. For example, simulator base 410 may include a haptic vibration motor 440 that generates a simulated thrill, thereby replicating the tactile sensation of a pulse or blood flow in a real vessel. Additionally, simulator base 410 may contain an array of light emitters 120 positioned beneath vessel module 420, wherein the emitters are arranged in a grid pattern and controlled via time-division multiplexing to provide spatial mapping of the needle's position relative to vessel module 420. In general, simulator base 410 may be communicatively coupled to a controller unit 900 that processes signals 124 from the light emitters 120 and other sensors to compute metrics such as needle trajectory, insertion velocity, and vessel entry events.

In accordance with further aspects of the disclosure, vessel module 420 may be implemented as a detachable and interchangeable component configured to simulate various vascular structures, such as peripheral veins, arteriovenous fistulas, synthetic grafts, or other anatomical features like the spine or lung. Accordingly, vessel module 420 may be securely mounted onto simulator base 410 through the common physical interface, which includes magnetic positioning aids 422 that precisely mate with the fixed magnets 412 on simulator base 410, thereby ensuring consistent spatial alignment necessary for accurate sensor readings and simulation fidelity.

For instance, vessel module 420 may embed a memory module comprising non-volatile memory, such as an EEPROM 430, to store unit-specific data including identification information, calibration parameters, and geometry information specific to vessel module 420. Upon connection to simulator base 410, the controller unit 900 may automatically read this data to configure the system for the particular anatomical structure being simulated. Moreover, the calibration parameters and geometry information may be used to adjust activation patterns of the light emitters 120 and to process signals 124 from the instrumented needle 801 for accurate detection of needle events, such as vessel entry or infiltration.

In another example, vessel module 420 may be designed to accommodate an instrumented medical needle 801 that includes an internal fiber optic waveguide 710 for detecting light signals emitted by the array of light emitters 120 in simulator base 410. Furthermore, vessel module 420 may include additional features, such as predefined boundaries for infiltration detection, which allow the controller unit 900 to determine if the needle tip has exited the simulated vessel. As a result, vessel module 420 can be configured to simulate specific anatomical scenarios, such as epidural spaces or biopsy points, by varying the arrangement of the light emitters 120 or incorporating additional sensors 252 for improved functionality.

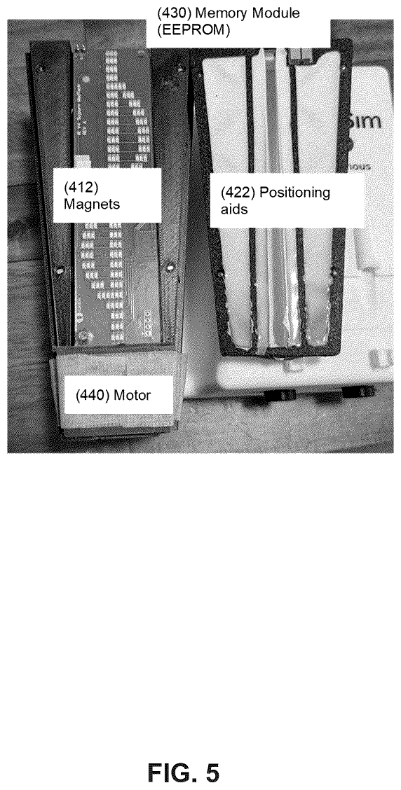

FIG. 5 illustrates a mechanical drawing of the simulator base components, including example magnets, positioning aids, a memory module, and a motor, in accordance with the techniques described herein. Magnets 412 are components of simulator base 410, designed to facilitate secure and repeatable alignment of modular anatomy units, such as vessel modules 420, relative to simulator base 410. For example, magnets 412 are fixed within simulator base 410 and interact with corresponding magnetic positioning aids 422 embedded in the modular anatomy units. In particular, this magnetic coupling ensures precise spatial alignment, which is necessary for maintaining the accuracy of sensor readings and the functionality of the light emitter array located beneath the modular anatomy unit. Accordingly, magnets 412 are strategically positioned to provide uniform magnetic force distribution, thereby preventing misalignment or displacement during operation. In general, the use of magnets 412 also enables rapid interchangeability of modular anatomy units, allowing users to seamlessly swap between different anatomical simulations without requiring manual recalibration.

Positioning aids 422 are embedded within the modular anatomy units and are configured to mate with fixed magnets 412 in simulator base 410. For example, positioning aids 422 comprise magnetic elements or ferromagnetic structures that align with magnets 412 to ensure repeatable spatial positioning of the modular anatomy unit relative to simulator base 410. In particular, positioning aids 422 provide a mechanical and magnetic interface that prevents rotational or translational misalignment, which could otherwise compromise the accuracy of the sensor system and the calibration parameters stored in memory module 430. In some examples, positioning aids 422 are designed to work in conjunction with the common physical interface of simulator base 410, thereby enabling modular anatomy units to be securely attached and detached with minimal effort while maintaining consistent alignment.

Memory module 430, implemented as an EEPROM (Electrically Erasable Programmable Read-Only Memory), is embedded within the modular anatomy unit and serves as a repository for data specific to the unit. For example, memory module 430 stores important information, including identification data, calibration parameters, and geometry information associated with the modular anatomy unit. Upon connection of the modular anatomy unit to simulator base 410, the controller automatically reads data stored in memory module 430 to configure the system for accurate simulation. Accordingly, the calibration parameters and geometry information are used to adjust processing of signals from the sensor system, thereby ensuring that the simulator operates in alignment with the anatomical characteristics of the attached module. In general, memory module 430 also facilitates interchangeability of modular anatomy units by enabling the controller to dynamically adapt to different modules without requiring manual input or recalibration.

Motor 440 is a haptic vibration motor integrated into simulator base 410 to enhance the realism of the simulation environment. For example, motor 440 is configured to generate a simulated thrill, mimicking the tactile sensation of a pulse or blood flow within a vascular structure. In particular, motor 440 is strategically positioned within simulator base 410 to ensure that vibration is transmitted effectively to the modular anatomy unit, thereby providing users with a realistic haptic feedback experience during training. In some examples, motor 440 can be controlled by the controller to vary intensity and frequency of vibration based on the simulation scenario, such as simulating different vascular conditions or patient-specific characteristics. Accordingly, inclusion of motor 440 adds a sensory dimension to the training simulator, improving fidelity of the simulation and aiding in the development of tactile skills for medical procedures.

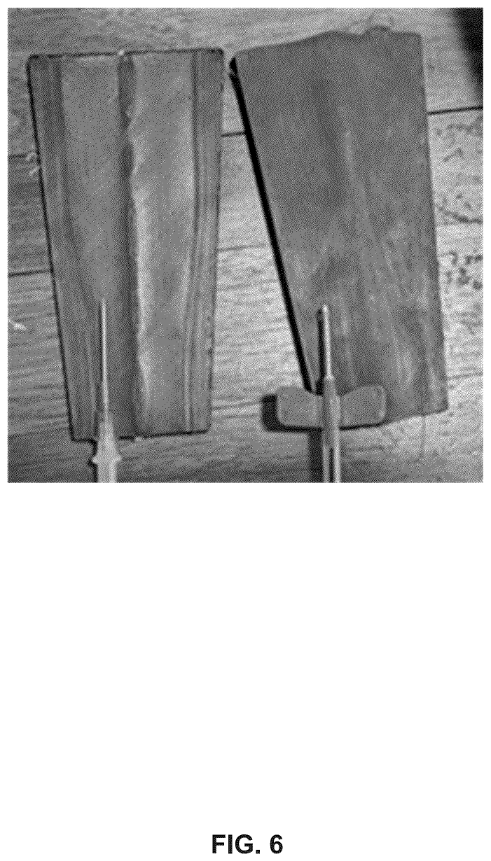

FIG. 6 is a photograph illustrating example modular anatomy units designed for cannulation training with instrumented medical needles, in accordance with the techniques described herein. In accordance with techniques of the disclosure, modular vessel units 420, as depicted in FIG. 6, form integral components of the cannulation training simulator system 100. For example, each modular vessel unit 420 is configured to simulate various vascular structures, including peripheral veins, arteriovenous fistulas, or synthetic grafts, and to be detachably interchangeable. In particular, each modular vessel unit 420 includes an embedded memory module, such as an EEPROM 430, that stores unit-specific data including identification, calibration parameters, and geometry information. Upon connection to the simulator base 410, the controller 900 automatically reads this data, thereby enabling precise calibration and alignment for a variety of training scenarios. Furthermore, the modular vessel units 420 are constructed to mimic the tactile and visual characteristics of biological tissues, providing a realistic simulation environment for medical training.

System 100 may incorporate magnetic positioning aids 422 that mate with fixed magnets 412 in the simulator base 410. Accordingly, this magnetic coupling ensures repeatable spatial alignment relative to the array of infrared emitters 120 located beneath the vessel module 420. The alignment is necessary for achieving precise detection and feedback during needle insertion and cannulation procedures. In some examples, the modular vessel units 420 are designed to accommodate different depths and geometries, thereby supporting a wide range of training scenarios, including peripheral vein cannulation and hemodialysis access.

In accordance with further aspects of the disclosure, instrumented medical needles 801 and 802 are provided for use with the modular vessel units 420. For instance, each needle is equipped with internal fiber optic sensors positioned at the distal tip of the needle. These fiber optic sensors are configured to detect light signals emitted by the array of infrared (IR) light emitters 120 beneath the modular vessel units 420. Upon detection, the signals are conveyed through a fiber optic waveguide 710 to a photodetector located in the controller 900 or simulator base 410, thus enabling precise determination of needle position and orientation. The instrumented medical needles 801 and 802 are capable of detecting vessel entry events, infiltration events, and other significant metrics during cannulation procedures. Moreover, each needle is associated with a visual indicator, such as an LED 811, that illuminates upon successful vessel entry detection, thereby providing immediate feedback to the user and enhancing the training experience. In an alternative example, the needles are compatible with various gauge sizes and insertion techniques required for specific vascular structures.

In some examples, visual indicators 811 and 812 are implemented as LEDs and are positioned on the instrumented medical needles 801 and 802 to ensure clear visibility during training sessions. Accordingly, these indicators illuminate upon receipt of a flashback confirmation signal from the controller 900, which is generated when the fiber optic sensor detects a vessel entry event. As a result, real-time feedback is provided to the user, aiding in the assessment of needle placement accuracy and technique.

In accordance with additional aspects of the disclosure, the simulated tissue material shown in FIG. 6 forms the external structure of the modular vessel units 420. For example, this material is designed to replicate the physical properties of human tissue, including elasticity, texture, and resistance to needle penetration, and to enhance the realism of the training experience by allowing users to practice needle insertion techniques in a controlled environment. Furthermore, the material is compatible with both the embedded memory module 430 and the magnetic positioning aids 422, thereby ensuring seamless integration with the simulator base 410 and light emitter array 120.

Although not explicitly visible in FIG. 6, the modular vessel units 420 incorporate magnetic positioning aids 422 that interact with fixed magnets 412 in the simulator base 410. These aids facilitate rapid swapping of modular vessel units 420, enabling users to transition between different training scenarios without compromising alignment or calibration. This feature enhances the modularity and adaptability of the cannulation training simulator system 100.

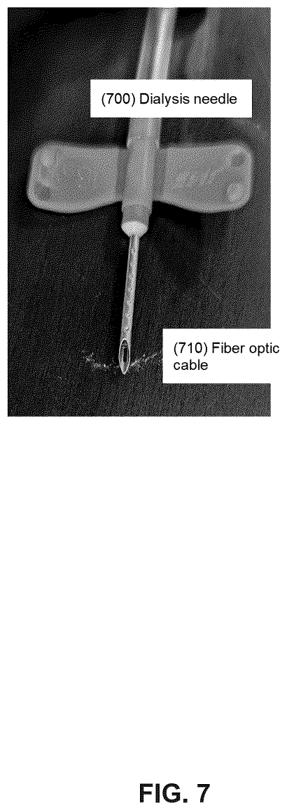

FIG. 7 is a photograph illustrating an example dialysis needle integrated with a fiber optic cable for light signal detection, in accordance with the techniques described herein. In accordance with techniques of the disclosure, dialysis needle 700 is a specialized medical instrument configured for use in the physical cannulation simulator system 100. For example, dialysis needle 700 is configured to simulate the insertion process into vascular structures, such as arteriovenous fistulas or synthetic grafts commonly employed in hemodialysis procedures. Specifically, dialysis needle 700 is constructed to replicate the physical characteristics of standard medical needles, including gauge, length, and tip geometry, thereby ensuring realistic tactile feedback during training. In general, needle 700 is compatible with the modular anatomy units of the simulator system, allowing trainees to practice precise insertion techniques while receiving real-time feedback on their performance.

In accordance with aspects of the disclosure, dialysis needle 700 is integrated with advanced sensing capabilities to enhance the simulation experience. For instance, fiber optic cable 710 is embedded within the structure of needle 700 to enable the detection and transmission of light signals. This integration allows needle 700 to interact with the electromagnetic position sensor system 118 of the simulator base, which includes an array of infrared emitters 120 positioned beneath the modular anatomy unit. Accordingly, dialysis needle 700 is further designed to work in conjunction with the control box 108, which processes signals from fiber optic cable 710 to determine metrics such as needle position, orientation, and vessel entry events.

In accordance with techniques of the disclosure, fiber optic cable 710 is a component of dialysis needle 700, embedded within the needle's structure and extending to the distal tip or nearby. Specifically, fiber optic cable 710 is configured to convey incident light from the distal tip to a photodetector located in the simulator base or control box 108. This functionality enables fiber optic cable 710 to serve as a light detection system, capturing light signals emitted by the array of infrared emitters 120 beneath the modular anatomy unit. In some examples, fiber optic cable 710 is designed to operate within the constraints of needle 700's geometry, ensuring minimal interference with the physical insertion process while maintaining sensitivity to light signals.

Additionally, fiber optic cable 710 interacts with the control box 108 to facilitate advanced signal processing. Upon detection of light signals, the control box 108 processes the data using anatomy-specific calibration parameters and geometry information stored in the embedded memory module 430 of the modular anatomy unit. As a result, the system can identify significant events such as vessel entry, infiltration, or needle trajectory. Furthermore, fiber optic cable 710 supports time-division multiplexing techniques, enabling the system to correlate detected light signals with specific emitters in the array. This correlation provides precise spatial mapping of the needle tip relative to the anatomy unit, improving the accuracy of the simulation.

Moreover, fiber optic cable 710 significantly contributes to facilitating sensor fusion within the simulator system. By integrating data from fiber optic cable 710 with signals from other sensors, such as optical hand tracking sensor system 112 or external camera system 122, the control box 108 can compute advanced metrics, including insertion velocity, needle trajectory, and deformation of simulated tissue. As a result, the simulator system is designed to deliver detailed feedback to trainees, enhancing their skill development in cannulation techniques.

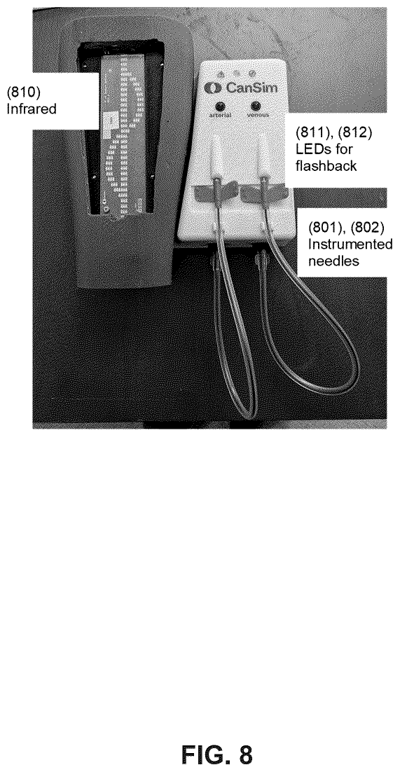

FIG. 8 is a photograph illustrating example simulator components, including instrumented needles, infrared emitters, and flashback LEDs, in accordance with the techniques described herein. Infrared array 810 may serve as an important component of the simulator system, being positioned beneath the modular anatomy unit to facilitate precise detection of needle events. For example, infrared array 810 may comprise a plurality of infrared (IR) emitters arranged in a specific pattern, such as a grid or clusters, depending on the anatomical simulation requirements. In an alternative example, these emitters may generate infrared signals that interact with the light detection system embedded within instrumented needles 801 and 802. Moreover, infrared array 810 may be controlled by the simulator's controller unit 900, which may sequence the emitters using time-division multiplexing (TDM) to create temporally distinct illumination patterns. These patterns, in turn, are necessary for correlating the detected signals to specific spatial locations and events, such as vessel entry or infiltration. Additionally, infrared array 810 may be designed to adapt to various modular anatomy units by utilizing calibration parameters and geometry information stored in the embedded memory module 430 of the anatomy unit. As a result, accurate spatial mapping and event detection may be achieved across different anatomical simulations, such as peripheral veins, arteriovenous fistulas, spinal columns, or lung biopsies.

System 120 may include visual indicators, for example, LEDs for flashback 811 and 812, which are associated with instrumented needles 801 and 802. In accordance with the disclosure, LEDs 811 and 812 may be configured to illuminate upon successful detection of a vessel entry event by the corresponding instrumented needle. For instance, the flashback confirmation signal may be generated by the controller unit 900 based on processed data from infrared array 810 and the fiber optic sensor 710 embedded within the needles. In some examples, LEDs 811 and 812 may provide immediate visual feedback to the user, thereby enhancing the realism and interactivity of the simulation. Each LED may be specifically linked to the corresponding needle, allowing for concurrent monitoring of multiple needles during a single cannulation trial. Furthermore, LEDs 811 and 812 may be strategically positioned to ensure clear visibility for the user, and their activation may be synchronized with other feedback mechanisms, such as haptic alerts or auditory signals, to provide a comprehensive training experience.

In general, instrumented needles 801 and 802 may comprise specialized medical needles designed for use within the simulator system. For example, each needle may be equipped with an internal fiber optic waveguide 710 that extends to or near the distal tip. The fiber optic waveguide 710 may be configured to capture incident infrared light emitted by infrared array 810 and convey the light to a photodetector located in the controller unit 900. Furthermore, instrumented needles 801 and 802 may detect precise needle events, such as vessel entry or infiltration, by processing the light signals in conjunction with calibration parameters and geometry information stored in the embedded memory module 430 of the modular anatomy unit. Moreover, the needles may be designed to simulate standard medical cannulation needles, thereby ensuring a realistic tactile experience for the user. In some examples, the system may support concurrent monitoring of multiple needles, as demonstrated by the inclusion of both needles 801 and 802 in FIG. 8, particularly beneficial for advanced training scenarios, such as dual-needle cannulation or procedures requiring simultaneous access to multiple anatomical sites. As a result, instrumented needles 801 and 802 may play a significant role in the simulator's capability to provide accurate feedback and metrics, including needle trajectory, insertion velocity, and event-based outcomes.

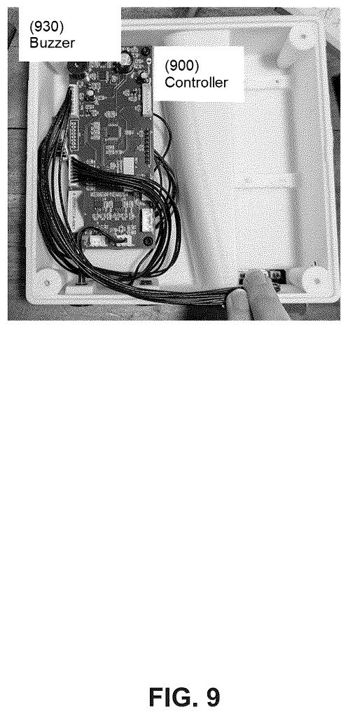

FIG. 9 is a photograph illustrating example controller and buzzer components of the medical training simulator system, in accordance with the techniques described herein. Controller 900 may serve as the central processing unit of the medical training simulator system, as depicted in FIG. 9. For example, controller 900 may be communicatively coupled to various system components, including the embedded memory module 430 of the modular anatomy unit, the sensor system comprising an array of light emitters 120, and the instrumented medical needle 801. Controller 900 may be an example of computing device 210 and computing device 110, and may perform similar operations and provide similar functionality. In operation, controller 900 may execute multiple significant functions, such as reading unit-specific data from the embedded memory module 430, processing signals received from the sensor system, and determining discrete needle events, for instance, vessel entry or infiltration.

In some examples, upon connection of the modular anatomy unit to the simulator base 410, controller 900 may automatically read calibration parameters and geometry information stored in the embedded non-volatile memory module 430. Accordingly, controller 900 may sequence the array of light emitters 120 via time-division multiplexing to generate temporally distinct illumination patterns. These patterns, in turn, may be used to correlate detections from the light detection system of the instrumented medical needle 801 to specific emitter contributions, thereby enabling precise determination of needle position, orientation, and events such as vessel entry. Furthermore, controller 900 may perform sensor fusion by integrating data from the light detection system with signals from additional sensors, such as motion-tracking systems 118 or external cameras 122, to compute advanced metrics, including needle trajectory, insertion velocity, and location-based events.

Moreover, controller 900 may transmit sensor data to an external computing device 110 running a digital-twin software model. For instance, the digital-twin model may process the transmitted data to simulate physical parameters such as stress, deformation, shear force, and fluid dynamics within the modular anatomy unit. As a result, controller 900 may provide real-time feedback to the user via a user interface 212, which may include a hardware display 202 or graphical user interface, displaying computed metrics such as outcome-based, process-based, motion-based, time-based, and event-based metrics.

In accordance with techniques of the disclosure, buzzer 930 may function as an alerting component integrated into the medical training simulator system, as shown in FIG. 9. Buzzer 930 may be communicatively coupled to controller 900 and may serve as a feedback mechanism to notify the user of specific events during simulation. For example, when controller 900 detects that the needle tip is positioned outside a predefined boundary of the modular anatomy unit, indicating an incorrect needle placement or potential damage to simulated anatomical structures, controller 900 may activate buzzer 930 to emit an audible alert.

Accordingly, this feedback mechanism may enhance the realism and educational value of the simulation by simulating real-world consequences of improper needle placement. In some embodiments, buzzer 930 may be configured to deactivate a flashback confirmation signal upon detection of an infiltration event, further emphasizing the occurrence of the event. In general, buzzer 930 may provide immediate and intuitive feedback to the user, thereby aiding in the development of proper cannulation techniques and reducing the likelihood of errors in real-world medical procedures.

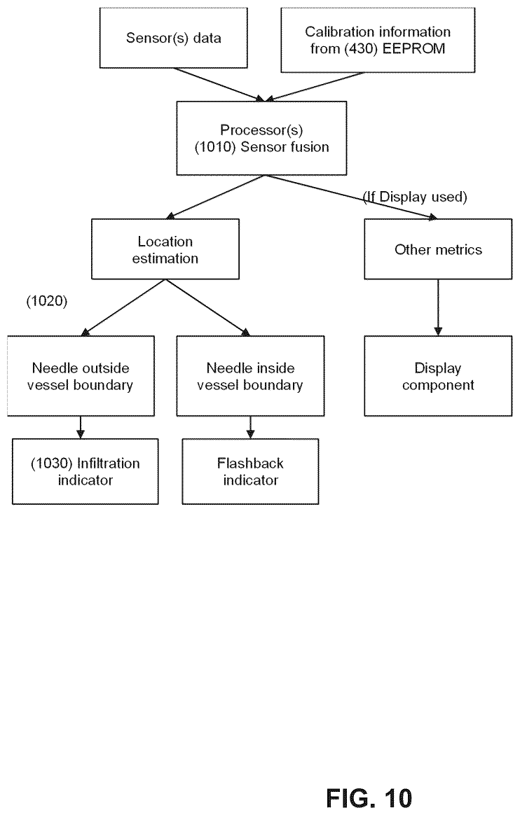

FIG. 10 illustrates a flowchart of an example sensor fusion process for determining needle position and generating feedback indicators, in accordance with the techniques described herein. In accordance with techniques of the disclosure, sensor(s) data serves as the primary input to the sensor fusion process depicted in FIG. 10. For example, this data may be collected from a light detection system embedded within the instrumented medical needle 801 and, in some instances, from additional sensors such as motion tracking systems 112 or external cameras 122 integrated into the physical cannulation simulator system 100. As a result, the sensor(s) data provides real-time information regarding the needle's position, orientation, trajectory, and interaction with the modular anatomy unit 302. In general, this data is significant for determining needle events, such as vessel entry or infiltration, and for calculating metrics related to the simulation. Moreover, the sensor(s) data is processed in conjunction with calibration information to ensure accurate and reliable results.

Accordingly, memory module 430, specifically an EEPROM, stores calibration information and geometry data specific to the modular anatomy unit 302. Upon connection of the modular anatomy unit 302 to the simulator base 410, the controller 900 automatically reads this calibration information, which includes parameters such as vessel depth, diameter, and predefined boundaries. For instance, the calibration data provides the anatomical context required to interpret the sensor(s) data accurately. As a result, the memory module 430 facilitates the system's adaptation to the specific characteristics of the modular anatomy unit 302 being used, enabling precise location estimation 1020 and event detection.

In accordance with techniques of the disclosure, processor(s) 1010 operates as the central computational component responsible for performing sensor fusion. Sensor fusion involves combining data from multiple sensors, including the light detection system and potentially other sensors such as motion trackers 112 or cameras 122, with the calibration information retrieved from memory module 430. For example, processor(s) 1010 may utilize advanced algorithms to correlate the sensor(s) data with calibration parameters, thereby determining needle events, such as vessel entry or infiltration, and computing metrics like needle trajectory, insertion velocity, and position. The sensor fusion process plays a significant role in ensuring accuracy and reliability in simulation outcomes, providing a thorough understanding of the needle's interaction with the modular anatomy unit 302.

In some embodiments, location estimation component 1020 operates as a sub-process within the sensor fusion system to determine the precise position of the needle 801 relative to the modular anatomy unit 302. Using fused data from processor(s) 1010, location estimation identifies whether the needle 801 is inside or outside the predefined vessel boundary. Accordingly, this determination plays a significant role in simulating realistic medical scenarios, such as successful vessel entry or infiltration events. Moreover, the location estimation process relies heavily on calibration information from memory module 430 and real-time sensor(s) data to ensure accurate spatial mapping of the needle's position.

In general, the needle outside vessel boundary condition is identified by location estimation component 1020 when the needle tip is detected outside the predefined boundary of the vessel module 420. In such cases, infiltration indicator 1030 is triggered to alert the user to an infiltration event. For example, the infiltration indicator 1030 may provide visual, auditory, or haptic feedback, such as activating a buzzer 930 or deactivating the flashback indicator 811. This functionality plays an important role in training users to recognize and respond to infiltration events during medical procedures.

Conversely, the needle inside vessel boundary condition is identified by location estimation component 1020 when the needle tip is detected within the predefined boundary of the vessel module 420. In this scenario, the flashback indicator 811 is triggered to provide confirmation of successful vessel entry. For instance, the flashback indicator 811 may include visual feedback, such as illuminating an LED associated with the instrumented medical needle 801. This functionality plays a significant role in simulating realistic feedback during cannulation training, aiding users in developing the skills necessary for accurate vessel entry.

Accordingly, infiltration indicator 1030 is activated when location estimation component 1020 detects that the needle tip lies outside the vessel boundary. In such examples, the infiltration indicator 1030 provides feedback that may include deactivating the flashback indicator 811 and activating a buzzer 930 or other alert mechanisms. This component is designed to simulate the consequences of an infiltration event, thereby helping users understand the importance of proper needle placement and develop the skills to avoid such events in real medical scenarios.

Similarly, the flashback indicator 811 is activated when location estimation component 1020 detects that the needle tip lies inside the vessel boundary. In accordance with techniques of the disclosure, this indicator provides confirmation of successful vessel entry by simulating the flashback phenomenon observed during real cannulation procedures. For example, an LED associated with the instrumented medical needle 801 may be illuminated to provide immediate and intuitive confirmation to the user.

Moreover, other metrics component represents additional calculations performed by processor(s) 1010 during the sensor fusion process. These metrics may include needle trajectory, insertion velocity, deformation of simulated tissue, stress on the modular anatomy unit 302, and cardiovascular fluid dynamics. As a result, other metrics component offers an extensive analysis of the simulation, allowing users to assess their performance and refine their skills. In some embodiments, these metrics may also be utilized for advanced training scenarios or research purposes.

In accordance with techniques of the disclosure, display component 1120 is responsible for presenting computed metrics and simulation outcomes to the user. For example, this component may include a hardware display, such as a multi-segment display, or a graphical user interface (GUI) running on an external computing device 1200. Display component 1120 offers real-time feedback, including outcome metrics, process metrics, motion-based metrics, time-based metrics, location-based metrics, and event-based metrics. By visualizing the simulation data, display component 1120 enhances the user experience and supports effective training.

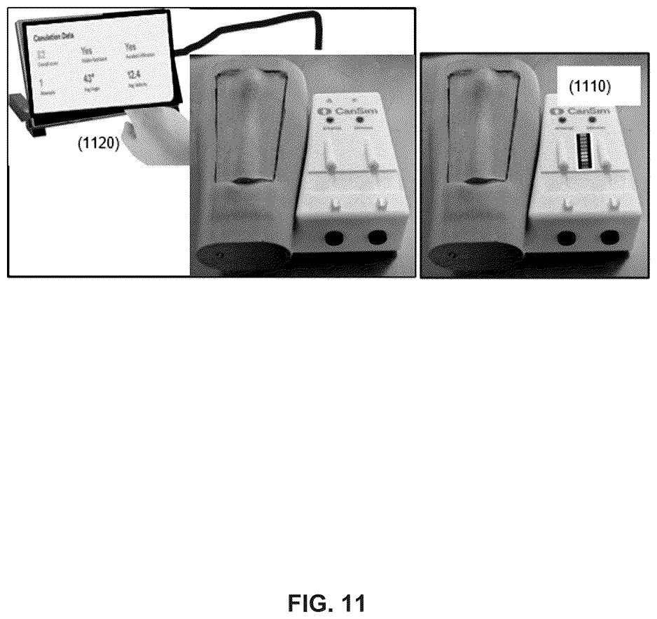

FIG. 11 is a photograph illustrating an example cannulation simulator system, including the simulator base unit with indicators and a display showing cannulation data, in accordance with the techniques described herein. Simulator base unit 1110 functions as the foundational platform for the cannulation training simulator system 100. Specifically, simulator base unit 1110 is configured to securely house and support modular anatomy units, such as vessel modules 420, through a common physical interface. For example, simulator base unit 1110 includes integrated indicators (e.g., visual elements such as light-emitting diodes (LEDs) 811, 812 or other visual cues) that illuminate to signal specific events, for instance, successful vessel entry or infiltration detection. In some examples, these indicators provide real-time feedback to the user during the simulation process, thereby enhancing procedural awareness.

Furthermore, simulator base unit 1110 is equipped with internal components, such as fixed magnets 412, which interact with magnetic positioning aids 422 on the modular anatomy units to ensure precise spatial alignment. This alignment is necessary for achieving accurate sensor readings and dependable simulation performance. In addition, simulator base unit 1110 houses an array of light emitters 120 positioned beneath the modular anatomy unit. These light emitters operate in accordance with time-division multiplexing to generate temporally distinct illumination patterns. As a result, the instrumented medical needle 801, 802 detects these patterns to determine needle position, orientation, and events such as vessel entry or infiltration.

Accordingly, the indicators integrated into simulator base unit 1110 are configured to provide immediate visual feedback to the user. For instance, upon successful vessel entry detection by the fiber-optic sensor 710 in the instrumented needle 801, 802, the corresponding indicator may illuminate to confirm the event. In an alternative example, in the case of an infiltration event, the indicators may deactivate the vessel entry confirmation signal and activate an alert, such as a buzzer 930 or a visual warning. These features contribute to improving the realism and interactivity of the simulation, enabling users to practice and refine their cannulation techniques with greater proficiency.

Display 1120 serves as a user interface component of the cannulation training simulator system 100, designed to present detailed cannulation data and metrics to the user. For example, display 1120 may be implemented as a hardware display or a graphical user interface (GUI) connected to the controller unit 900. Display 1120 is configured to show real-time and computed metrics derived from the sensor system 252 and controller processing. These metrics may include outcome metrics, process metrics, motion-based metrics, time-based metrics, location-based metrics, and event-based metrics.

In some examples, display 1120 is communicatively coupled to the controller unit 900, which processes data from the embedded memory module 430, the light detection system 120, and other sensors, such as motion-tracking systems 112 or external cameras 122. Following this processing, the controller 900 transmits the data to display 1120, enabling the user to monitor their performance during the simulation. For instance, display 1120 may show metrics such as needle trajectory, insertion velocity, vessel entry confirmation, infiltration detection, and overall performance scores.

Moreover, display 1120 may provide visualizations of complex parameters calculated by the digital twin software model 226, such as stress on the modular anatomy unit, deformation of simulated tissue, shear force, and fluid dynamics. As a result, users gain a deeper understanding of the physical interactions and forces involved in cannulation procedures. In general, display 1120 enhances the educational value of the simulator by providing comprehensive and actionable feedback, which supports users in refining their skills and achieving improved outcomes in real-world medical scenarios.

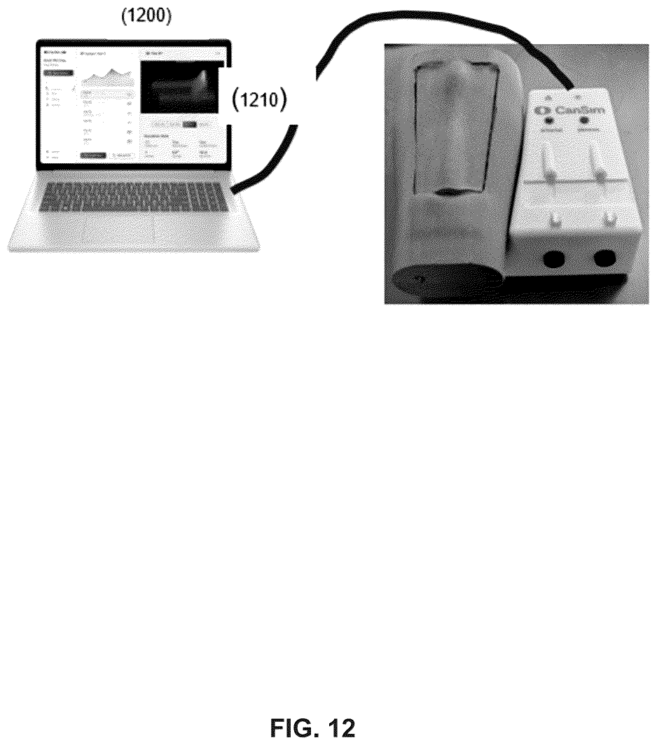

FIG. 12 illustrates a system diagram of an example cannulation training simulator system connected to a laptop with a user interface via a communication cable, in accordance with the techniques described herein. In accordance with techniques of the disclosure, laptop 1200 may serve as an external computing device 110 that provides a graphical user interface (GUI) for the cannulation training simulator system 100. For example, the GUI displayed on laptop 1200 may be configured to present real-time data, computed metrics, and feedback to the user during a simulation session. In some examples, the GUI may include visualizations of needle trajectory, insertion velocity, vessel entry events, and additional process or outcome metrics derived from sensor data 114, 118, and 116. Accordingly, laptop 1200 may be communicatively coupled to the simulator base controller 108 via connection cable 1210 to enable bidirectional data exchange. In general, laptop 1200 may also execute advanced software, including a digital twin model, to simulate physical parameters such as stress, deformation, shear force, and fluid dynamics of the modular anatomy unit 302. As a result, laptop 1200 may store training session data for post-simulation analysis and performance evaluation.

In some examples, connection cable 1210 may establish a physical communication link between laptop 1200 and the cannulation training simulator base 104. For instance, cable 1210 may facilitate transfer of data, such as controller signals 124 and sensor outputs 114, 118, and 116, from the simulator base 104 to laptop 1200 for real-time processing and visualization. Conversely, cable 1210 may transmit control signals from laptop 1200 to the simulator base 104, including commands for activating specific light emitter patterns 120 or initiating haptic feedback mechanisms 440. As a result, connection cable 1210 may be designed to ensure reliable, high-speed data transmission, which is necessary for maintaining system responsiveness during training. In some embodiments, connection cable 1210 may implement standard communication protocols, such as USB or Ethernet, depending on system configuration.

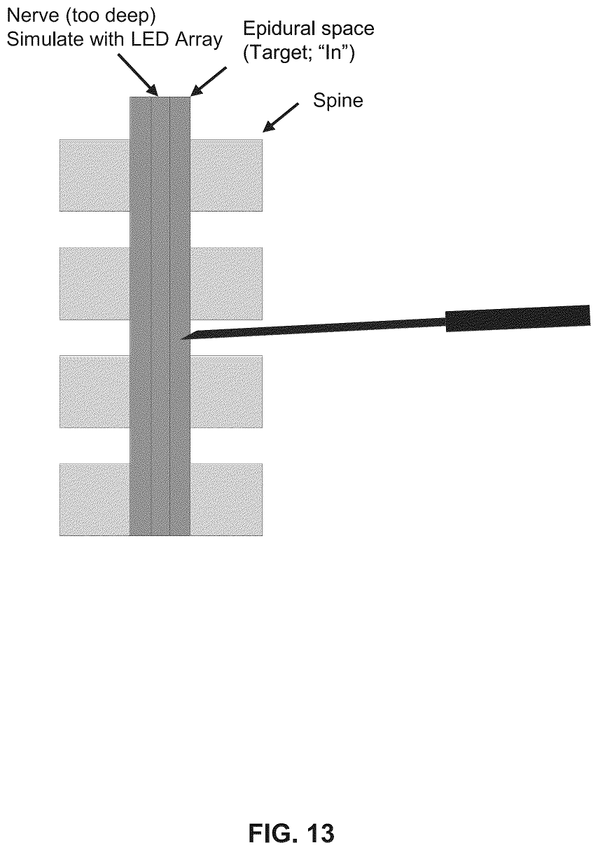

FIG. 13 illustrates a biological diagram of an example epidural simulation using an LED array to differentiate the epidural space from deeper nerve structures near the spine, in accordance with the techniques described herein. The nerve simulation component depicted in FIG. 13 is configured to represent anatomical structures that are located deeper than the epidural space, such as nerves or other significant tissues. For example, this component may employ an LED array positioned to correspond to the anatomical location of the nerve. The LED array is configured to emit light signals that are detectable by the instrumented medical needle 801, 802 based at least in part on a light detection system, such as a fiber-optic sensor 710. Accordingly, the emitted light signals simulate the interaction between the needle and the nerve, thereby providing feedback to the user when the needle penetrates too deeply and contacts the simulated nerve.

In some examples, the LED array is arranged in a linear configuration rather than a grid pattern, since the focus is on detecting the depth of the needle relative to the nerve rather than mapping the spatial boundaries of a vessel. The controller unit 900 processes signals from the LED array and the needle's light detection system to determine whether the needle has entered the nerve region. If the needle contacts the simulated nerve, the system may trigger an alert, such as activating a buzzer 930 or deactivating a confirmation signal, to inform the user of incorrect needle placement. In general, this feature plays an important role in training users to avoid damaging sensitive anatomical structures during procedures like epidural injections.

The epidural space simulation component shown in FIG. 13 represents the target region for needle placement during an epidural procedure. For instance, this component is designed to mimic the anatomical characteristics of the epidural space, which is the intended location for needle insertion. The LED array associated with the epidural space is configured to emit light signals that are detectable by the instrumented medical needle 801, 802 when the needle tip enters the simulated epidural space. These emitted light signals are processed by the controller unit 900 to confirm successful entry into the target region.

In an alternative example, the system is calibrated to differentiate between the epidural space and adjacent anatomical structures, such as the nerve or spinal cord, using geometry information stored in the embedded memory module 430 of the modular anatomy unit. The controller unit 900 utilizes this information to sequence the LED array via time-division multiplexing, thereby ensuring precise detection of the needle's position and orientation relative to the epidural space. Upon successful entry into the epidural space, the system can provide feedback to the user, such as illuminating a visual indicator or generating a confirmation signal, to simulate the “flashback” effect experienced during real procedures.

The spine component depicted in FIG. 13 represents the anatomical structure surrounding both the epidural space and nerve regions. For example, this component may be simulated using a physical model integrated into the modular anatomy unit, which can include touch sensors or other detection mechanisms to identify contact between the needle and the spine. The spine simulation plays a significant role in training users to avoid penetrating the spinal cord or other sensitive structures during epidural procedures.

In some examples, the LED array associated with the spine is configured to emit light signals that are detectable by the instrumented medical needle 801, 802 when the needle approaches or contacts the spine. The controller unit 900 processes these signals to determine whether the needle has entered the spinal cord or other regions of the spine. If the needle contacts the spine, the system may trigger an alert, such as activating a buzzer 930 or deactivating a confirmation signal, to inform the user of incorrect needle placement. This feature plays a significant role in training users to perform epidural procedures safely and accurately, thereby reducing the likelihood of complications associated with spinal cord injury.

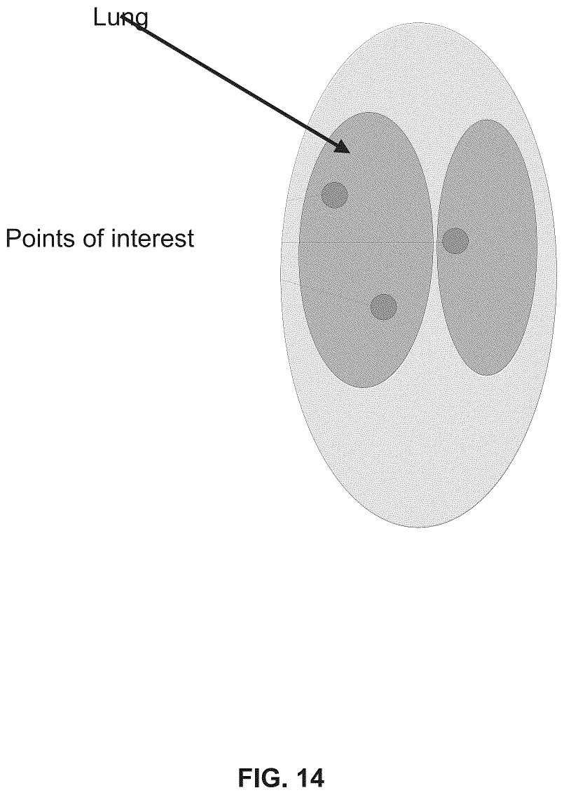

FIG. 14 illustrates a biological diagram of an example lung with designated points of interest for biopsy procedures, in accordance with the techniques described herein. In accordance with techniques of the disclosure, lung module represents a modular anatomy unit configured to simulate the anatomical structure and functionality of a human lung for medical training purposes. For example, lung module is detachably interchangeable with other anatomy units via a common physical interface as recited in the claims. In particular, the lung module includes an embedded memory module containing non-volatile memory, such as an electrically erasable programmable read-only memory (EEPROM) 430, which stores unit-specific data including module identification, calibration parameters, and geometric information. Based at least in part on the calibration parameters and geometry information retrieved from the embedded memory module 430, a controller 900 configures both the sensor system 252 and an array of light emitters 120 arranged beneath the common physical interface to accurately simulate the lung's physical characteristics and behavior during procedures such as biopsies. In some examples, the lung module may be constructed from ultrasound-compatible materials, thereby enabling real-time ultrasound imaging during training sessions to enhance realism and support precise needle placement.

In accordance with techniques of the disclosure, points of interest within lung module are specific regions designated for targeted medical procedures, such as biopsies. For instance, each point of interest is co-located with a cluster of infrared (IR) emitters 120 positioned beneath the modular anatomy unit, and these emitters generate optical signals 124 that can be detected by the light detection system of an instrumented medical needle 801. The controller 900 processes the detected signals 124, using the calibration parameters and geometric information stored in the embedded memory module 430, to determine the needle's position and orientation relative to the points of interest. Accordingly, the clustered arrangement of IR emitters 120 enables precise spatial mapping and ensures that the simulation focuses on accurate targeting rather than merely detecting needle entry events. In an alternative example, the points of interest may also interact with additional sensors, such as motion-tracking systems 112 or external cameras 122, to provide comprehensive feedback on procedural accuracy. The collected data can then be processed by the controller 900 or transmitted to an external computing device 110 running a digital-twin software model to calculate advanced metrics, for example, tissue deformation and stress distribution around the designated points of interest.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAS), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A medical training simulator system comprising:
a simulator base configured to receive and support any of a plurality of modular anatomy units through a common physical interface;
a first modular anatomy unit of the plurality of modular anatomy units, the first modular anatomy unit being detachably interchangeable with other of the plurality of modular anatomy units having different calibration information and geometry information, the first modular anatomy unit including an embedded memory module comprising non-volatile memory storing unit-specific data including identification, calibration parameters, and geometry information for the first modular anatomy unit;
a sensor system configured to detect a position of a needle relative to the first modular anatomy unit, the sensor system comprising:
an array of light emitters disposed beneath the common physical interface that receives the first modular anatomy unit; and
an instrumented medical needle having a light detection system; and
a controller communicatively coupled to the embedded memory module and the sensor system, the controller being configured to:
automatically read the unit-specific data from the non-volatile memory upon connection of the modular anatomy unit to the simulator base; and
configure processing of signals from the sensor system based on the calibration parameters and geometry information to determine at least a vessel entry event and provide user feedback.

2. The system of claim 1, further comprising:
an infiltration detection system configured to:
utilize data from the light detection system and the unit-specific data to determine, by the controller, an infiltration event when the needle tip is detected outside a predefined boundary of the first modular anatomy unit; and
provide an infiltration alert to the user.

3. The system of claim 1, wherein the array of light emitters is arranged in a grid pattern, and wherein the controller is configured to sequence the emitters via time-division multiplexing based on the geometry information for the first modular anatomy unit.

4. The system of claim 1, further comprising:
a second instrumented medical needle, wherein the controller is configured to monitor positions of the first and second instrumented medical needles concurrently during a single cannulation trial.

5. The system of claim 4, further comprising:
a visual indicator associated with each instrumented medical needle, each visual indicator comprising a light-emitting diode that illuminates upon detection of the vessel entry event by the corresponding instrumented medical needle.

6. The system of claim 1, wherein the common physical interface comprises magnetic couplings;
the simulator base including a plurality of fixed magnets; and
the plurality of modular anatomy units including magnetic positioning aids configured to mate with the fixed magnets to ensure repeatable spatial alignment of the modular anatomy unit relative to the array of light emitters.

7. The system of claim 1, wherein the plurality of modular anatomy units is configured to simulate anatomical structures selected from the group consisting of:
a peripheral vein;
an arteriovenous fistula;
a synthetic graft;
a spine and spinal cord arrangement; and
a lung.

8. The system of claim 1, wherein the controller is further configured to perform sensor fusion to determine metrics comprising needle trajectory, insertion velocity, and precise needle events by processing signals from the sensor system and signals from at least one additional sensor selected from the group consisting of:
a motion tracking system;
a force sensor;
a hand tracking system;
an inertial measurement unit; and
an external camera,

9. The system of claim 1, further comprising:
a user interface coupled to the controller, the user interface comprising a hardware display or a graphical user interface, the user interface configured to display one or more computed metrics including at least one of:
outcome metrics;
process metrics;
motion-based metrics;
time-based metrics;
location-based metrics; and
event-based metrics.

10. The system of claim 1, wherein the controller is communicatively coupled to an external computing device running a digital twin software model, the controller configured to transmit signals from the light detection system to the external computing device for processing by the digital twin software model to calculate parameters including:
stress on the modular anatomy unit;
deformation of simulated tissue;
shear force; and
fluid dynamics.

11. The system of claim 1, wherein the light detection system of the instrumented medical needle comprises an internal fiber optic waveguide extending to or proximate a distal tip of the needle, the internal fiber optic waveguide being configured to convey incident light from the distal tip to a photodetector located in the base or the controller, the controller processing signals derived therefrom based on the anatomy-specific calibration parameters and geometry information to detect at least a vessel entry event.

12. The system of claim 1, wherein the controller is configured to selectively activate different patterns of the array of light emitters for sensor readings based on the calibration parameters and geometry information stored in the embedded memory module for the first modular anatomy unit.

13. The system of claim 1, wherein the first modular anatomy unit comprises a model of a lung, and wherein the array of light emitters are arranged in clusters in areas where a biopsy is to be performed.

14. The system of claim 1, wherein the first modular anatomy unit comprises a model of a spine, and wherein at least a portion of the array of light emitters are arranged to model a spinal cord such that, if the light detection system detects light emitted by any of the portion of the array of light emitters, the light detection system indicates that the instrumented medical needle passed a simulated epidural space and entered the spinal cord.

15. The system of claim 1, wherein the sensing arrangement comprises an infrared sensing system, and wherein the controller is further configured to:
estimate outputs of one or more additional sensors including at least one of a motion sensor and a force sensor by applying model-based or data-driven inference techniques that map temporally distinct infrared detections, identified emitter contributions, and geometry-constrained needle tip trajectories to generate surrogate kinematic signals and interaction force signals, the controller performing the estimation based on the calibration parameters and geometry information stored in the EEPROM.

16. The system of claim 1, further comprising one or more additional sensors, wherein the controller is further configured to estimate spatial information of the instrumented medical needle from sensor data gathered by the one or more additional sensors to generate a prediction of cannulation performance based on the positioning of the instrumented medical needle or a user posture relative to the vessel module, the sensor data including user behavior prior to insertion of the instrumented medical needle.

17. A method of detecting needle events and determining needle position and orientation in a medical simulator, the method comprising:
receiving, at a simulator base, a modular anatomy unit comprising an embedded non-volatile memory storing anatomy-specific calibration parameters and geometry information;
reading, by a controller, the anatomy-specific calibration parameters and geometry information from the embedded non-volatile memory;
sequencing, by the controller, an array of light emitters using time-division multiplexing to generate a plurality of temporally distinct illumination patterns defined in accordance with the calibration parameters and geometry information;
detecting, by a light detection system of an instrumented medical needle, light corresponding to the temporally distinct illumination patterns while the instrumented medical needle is manipulated relative to the modular anatomy unit;
correlating, by the controller, detections from the light detection system to the temporally distinct illumination patterns to identify emitter contributions and to determine at least one needle event; and
processing, by the controller, the correlated detections using the calibration parameters and geometry information to compute a needle position and orientation associated with the at least one needle event.

18. The method of claim 17, further comprising:
performing sensor fusion by processing signals from the light detection system and at least one additional sensor selected from the group consisting of a motion tracking system, a force sensor, a hand tracking system, an inertial measurement unit, and an external camera to determine metrics comprising needle trajectory and insertion velocity.

19. The method of claim 17, further comprising:
monitoring positions of first and second instrumented medical needles concurrently during a single cannulation trial; and
correlating detections for each needle to determine respective needle events.

20. The method of claim 19, further comprising:
illuminating a visual indicator associated with each instrumented medical needle upon occurrence of a vessel entry event for the corresponding needle.

21. The method of claim 17, further comprising:
transmitting the correlated detections to an external computing device running a digital twin software model; and
calculating at least one parameter selected from the group consisting of stress on the modular anatomy unit, deformation of simulated tissue, shear force, and fluid dynamics.

22. The method of claim 17, wherein detecting light comprises conveying incident light from a distal tip of the instrumented medical needle through an internal fiber optic waveguide to a photodetector of the controller.

23. The method of claim 17, wherein the temporally distinct illumination patterns correspond to a grid pattern arrangement of the array of light emitters.

24. The method of claim 17, wherein receiving the modular anatomy unit comprises coupling, via a common physical interface, a selected one of a plurality of detachably interchangeable modular anatomy units, each modular anatomy unit including an embedded non-volatile memory storing anatomy-specific identification, calibration parameters, and geometry information, and wherein coupling includes magnetically mating positioning aids of the selected modular anatomy unit to fixed magnets of the simulator base to provide repeatable spatial alignment relative to the array of light emitters.

25. The method of claim 17, further comprising:
determining an infiltration event when the detected needle tip is positioned outside a predefined boundary of the modular anatomy unit; and
providing an infiltration alert to a user.

26. The method of claim 17, further comprising:
estimating, by the controller, outputs of one or more additional sensors including at least one of a motion sensor and a force sensor by applying model-based or data-driven inference techniques that map temporally distinct infrared detections, identified emitter contributions, and geometry-constrained needle tip trajectories to generate surrogate kinematic signals and interaction force signals, the estimating being performed based on the calibration parameters and geometry information read from the embedded non-volatile memory.

27. The method of claim 17, wherein sequencing comprises selectively activating different patterns of the array of light emitters based on the calibration parameters and geometry information.

28. The method of claim 17, further estimating, by the controller, spatial information of the instrumented medical needle from sensor data gathered by one or more additional sensors to generate a prediction of cannulation performance based on the positioning of the instrumented medical needle or a user posture relative to the vessel module, the sensor data including user behavior prior to insertion of the instrumented medical needle.
